(19) United States
(12) Patent Application Publication
(10) Pub. No.: US 2025/0232784 A1
(43) Pub. Date: Jul. 17, 2025

(54) DISPLAY METHOD RELATING TO SOUND WAVEFORM CHARACTERISTIC DISTRIBUTION

(71) Applicant: Yamaha Corporation, Hamamatsu (JP)

(72) Inventors: Ryunosuke DAIDO, Hamamatsu (JP); Keijiro SAINO, Hamamatsu (JP); Masanari NISHIMURA, Hamamatsu (JP); Masahiro SHIMIZU, Hamamatsu (JP)

(21) Appl. No.: 19/169,733

(22) Filed: Apr. 3, 2025

Related U.S. Application Data
(63) Continuation of application No. PCT/JP2023/035437, filed on Sep. 28, 2023.
(60) Provisional application No. 63/412,887, filed on Oct. 4, 2022.

(30) Foreign Application Priority Data
Dec. 28, 2022 (JP) 2022-212415
Mar. 17, 2023 (JP) 2023-043561

(51) Int. Cl. G10L 21/10; G10L 15/06; G10L 15/22; G10L 25/30

(52) U.S. Cl. CPC G10L 21/10; G10L 15/063; G10L 15/22; G10L 25/30

(57) ABSTRACT

A method for displaying information relating to an acoustic model that is established by being trained using a plurality of sound waveforms so as to generate acoustic features includes acquiring characteristic distribution of the plurality of sound waveforms used for training of the acoustic model. A characteristic of the characteristic distribution is one or more sound waveform characteristics.

### CROSS-REFERENCE TO RELATED APPLICATIONS

This application is a continuation application of International Application No. PCT/JP2023/035437, filed on Sep. 28, 2023, which claims priority to U.S. Provisional Patent Application No. 62/412,887, filed on Oct. 4, 2022, Japanese Patent Application No. 2023-043561 filed in Japan on Mar. 17, 2023, and Japanese Patent Application No. 2022-212415 filed in Japan on Dec. 28, 2022. The entire disclosures of U.S. Provisional Patent Application No. 62/412,887, Japanese Patent Application No. 2023-043561, and Japanese Patent Application No. 2022-212415 are hereby incorporated herein by reference.

### BACKGROUND

### Technical Field

One embodiment of this disclosure relates to a display method relating to a characteristic distribution of a sound waveform.

### Background Information

Sound synthesis technology for synthesizing voice of specific singers and performance sounds of specific musical instruments is known. In particular, in sound synthesis technology using machine learning (for example, Japanese Laid-Open Patent Application No. 2020-076843 and International Publication No. 2022/080395), a sufficiently trained acoustic model is required in order to output synthesized sounds with natural pronunciation for the specific voice and performance sounds, based on musical score data and audio data input by a user.

### SUMMARY

In order to obtain a sufficiently trained acoustic model, it is necessary to accurately ascertain the sound range that is lacking in the current acoustic model and to select a sound waveform for training suitable for compensating for said range. However, it is extremely difficult to accurately ascertain the sound range that is lacking in an acoustic model, as described above, and it has been difficult to accurately and efficiently identify a sound waveform to use for training.

One object of one embodiment of this disclosure is to facilitate identification of a sound waveform to use for training an acoustic model.

According to one embodiment of this disclosure, a method for displaying information relating to an acoustic model that is established by being trained using a plurality of sound waveforms so as to generate acoustic features comprises acquiring characteristic distribution of the plurality of sound waveforms used for training of the acoustic model, a characteristic of the characteristic distribution being one or more sound waveform characteristics.

### BRIEF DESCRIPTION OF THE DRAWINGS

FIG. 1 is an overall configuration diagram of an acoustic model training system.

FIG. 2 is a configuration diagram of a server.

FIG. 3 is an explanatory diagram of an acoustic model.

FIG. 4 is a sequence diagram illustrating an acoustic model training method.

FIG. 5 is a flowchart illustrating a training process for an acoustic model and a display process for a characteristic distribution of a sound waveform.

FIG. 6 is one example of a characteristic distribution of a sound waveform.

FIG. 7 is a modified example of a flowchart illustrating a method for displaying a characteristic distribution of a sound waveform.

FIG. 8 is a flowchart illustrating a training process for an acoustic model.

FIG. 9 is one example of a graphical display of a lacking range.

FIG. 10 is one example of a characteristic distribution of a musical piece to be recommended to a user.

FIG. 11 is a flowchart illustrating a process of selecting, editing, and playing a musical piece.

FIG. 12 is one example of a display of recommended musical pieces based on the degree of proficiency.

FIG. 13 is one example of a piano roll display.

FIG. 14 is one example of a characteristic distribution of a sound waveform.

FIG. 15 is a flowchart illustrating a process of a musical piece play process.

FIG. 16 is a diagram explaining a project overview of a service according to one embodiment of this disclosure.

FIG. 17 is a diagram providing background information of the service according to one embodiment of this disclosure.

FIG. 18 is a diagram explaining an overview of functions of the service according to one embodiment of this disclosure.

FIG. 19 is a diagram explaining an overview of functions of the service according to one embodiment of this disclosure.

FIG. 20 is a diagram explaining an overview of functions of the service according to one embodiment of this disclosure.

FIG. 21 is a diagram explaining implementation of the service according to one embodiment of this disclosure.

FIG. 22 is a diagram explaining a system configuration of the service according to one embodiment of this disclosure.

FIG. 23 is a diagram explaining future plans as a commercial service regarding the service according to one embodiment of this disclosure.

FIG. 24 is a diagram showing a conceptual image of a structure of the service according to one embodiment of this disclosure.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

A display method relating to a characteristic distribution of a sound waveform according to one embodiment of this disclosure will be described in detail below, with reference to the drawings. The following embodiments are merely examples of embodiments for implementing this disclosure, and this disclosure is not to be construed as being limited to these embodiments. In the drawings being referenced in the present embodiment, parts that are the same or that have similar functions are assigned the same or similar symbols (symbols in which A, B, etc., are simply added after numbers), and redundant explanations can be omitted.

In the following embodiments, “musical score data” are data including information relating to the pitch and intensity of notes, information relating to the phonemes of notes, information relating to the pronunciation periods of notes, and information relating to performance symbols. For example, musical score data are data representing the musical score and/or lyrics of a musical piece. The musical score data can be data representing a time series of notes constituting the musical piece, or can be data representing the time series of language constituting the musical piece.

“Sound waveform” refers to waveform data of sound. A sound source that emits the sound is identified by a sound source ID (identification). For example, a sound waveform is waveform data of singing and/or waveform data of musical instrument sounds. For example, the sound waveform includes waveform data of a singer's voice and performance sounds of a musical instrument captured via an input device, such as a microphone. The sound source ID identifies the timbre of the singer's singing or the timbre of the performance sounds of the musical instrument. Of the sound waveforms, a sound waveform that is input in order to generate synthetic sound waveforms using an acoustic model is referred to as “sound waveform for synthesis,” and a sound waveform used for training an acoustic model is referred to as “sound waveform for training.” When there is no need to distinguish between a sound waveform for synthesis and a sound waveform for training, the two are collectively referred to simply as “sound waveform.”

An “acoustic model” has an input of musical score features of musical score data and an input of acoustic features of sound waveforms. As an example, an acoustic model that is disclosed in International Publication No. 2022/080395 and that has a musical score encoder, an acoustic encoder, a switching unit, and an acoustic decoder is used as the acoustic model. This acoustic model is a sound synthesis model obtained by processing the musical score features of the musical score data that have been input, or by processing the acoustic features of a sound waveform and a sound source ID. The acoustic model is a sound synthesis model used by a sound synthesis program. The sound synthesis program has a function for generating acoustic features of a target sound waveform having the timbre indicated by the sound source ID, and is a program for generating a new synthetic sound waveform. . . . The sound synthesis program supplies, to an acoustic model, the sound source ID and the musical score features generated from the musical score data of a particular musical piece, to obtain the acoustic features of the musical piece in the timbre indicated by the sound source ID, and converts the acoustic features into a sound waveform. Alternatively, the sound synthesis program supplies, to an acoustic model, the sound source ID and the acoustic features generated from the sound waveform of a particular musical piece, to obtain new acoustic features of the musical piece in the timbre indicated by the sound source ID, and converts the new acoustic features into a sound waveform. A prescribed number of sound source IDs are prepared for each acoustic model. That is, each acoustic model selectively generates acoustic features of the timbre indicated by the sound source ID, from among a prescribed number of timbres.

An acoustic model is a generative model of a prescribed architecture that uses machine learning, such as a convolutional neural network (CNN) or a recurrent neural network (RNN). Acoustic features represent the features of sound generation in the frequency spectrum of the waveform of a natural sound or a synthetic sound. Acoustic features being similar means that the timbre, or the temporal change thereof, in a singing voice or in performance sounds is similar.

When training an acoustic model, variables of the acoustic model are changed such that the acoustic model generates acoustic features that are similar to the acoustic features of the referenced sound waveform. For example, the training program P2, the musical score data D1 (musical score data for training), and the audio data for learning D2 (sound waveform for training) disclosed in International Publication No. 2022/080395 are used for training. Through basic training using waveforms of a plurality of sounds corresponding to a plurality of sound source IDs, variables of the acoustic model (musical score encoder, acoustic encoder, and acoustic decoder) are changed so that it is possible to generate acoustic features of synthetic sounds with a plurality of timbres corresponding to the plurality of sound source IDs. Furthermore, by subjecting the trained acoustic model to supplementary training using a sound waveform of a different timbre corresponding to a new (unused) sound source ID, it becomes possible for the acoustic model to generate acoustic features of the timbre indicated by the new sound source ID. Specifically, by further subjecting a trained acoustic model trained using sound waveforms of the voices of XXX (multiple people) to supplementary training using a sound waveform of the voice of YYY (one person) using a new sound source ID, variables of the acoustic model (at least the acoustic decoder) are changed so that the acoustic model can generate the acoustic features of YYY's voice. A unit of training for an acoustic model corresponding to a new sound source ID, such as that described above, is referred to as a “training job.” That is, a training job means a sequence of training processes that is executed by a training program.

A “program” refers to a command or a group of commands executed by a processor in a computer provided with the processor and a memory unit. A “computer” is a collective term referring to a means for executing programs. For example, when a program is executed by a server (or a client), the “computer” refers to the server (or client). When a “program” is executed by distributed processing between a server and a client, the “computer” includes both the server and the client. In this case, the “program” includes a “program executed by a server” and a “program executed by a client.” Similarly, when a “program” is executed by distributed processing between a plurality of computers connected to a network, the “computer” is a plurality of computers, and the “program” includes a plurality of programs executed by the plurality of computers.

### 1. First Embodiment

### 1-1. Overall System Configuration

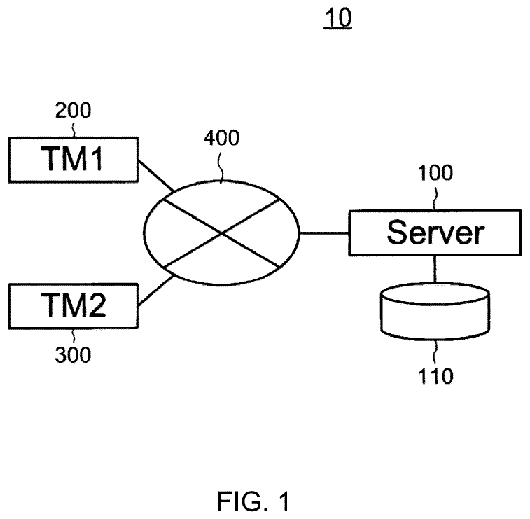

FIG. 1 is an overall configuration diagram of an acoustic model training system. As shown in FIG. 1, an acoustic model training system 10 comprises a could server 100 (server), a communication terminal 200 (TM1), and a communication terminal 300 (TM2). The server 100 and the communication terminals 200, 300 are each connected to a network 400. The communication terminal 200 and the communication terminal 300 can each communicate with the server 100 via the network 400.

In the present embodiment, the server 100 is a computer that functions as a sound synthesizer and carries out training of acoustic models. The server 100 is provided with storage 110. FIG. 1 illustrates a configuration in which the storage 110 is directly connected to the server 100, but the invention is not limited to this configuration. For example, the storage 110 can be connected to the network 400 directly or via another computer, and data can be received and transmitted between the server 100 and the storage 110 via the network 400.

The communication terminal 200 is a terminal of a user (creator, described further below) for selecting a training sound waveform for training an acoustic model and sending an instruction to the server 100 to execute the training. For example, the communication terminal 300 is a user terminal that provides musical score data and requests the server 100 to generate synthetic sound waveforms. The communication terminals 200, 300 include mobile communication terminals, such as smartphones, and stationary communication terminals such as desktop computers. The training method of this disclosure can be implemented by a configuration other than the client-server configuration described in the present embodiment. For example, the training method can be implemented with a single electronic device such as a smartphone, a PC, an electronic instrument, or an audio device equipped with a processor that can execute a program, instead of a system that includes a communication terminal and a server. Alternatively, the training method can be implemented as distributed processing by a plurality of electronic devices connected via a network.

The network 400 can be the common Internet, a Wide Area Network (WAN), or a Local Area Network (LAN), such as a corporate LAN.

### 1-2. Configuration of a Server Used for Sound Synthesis

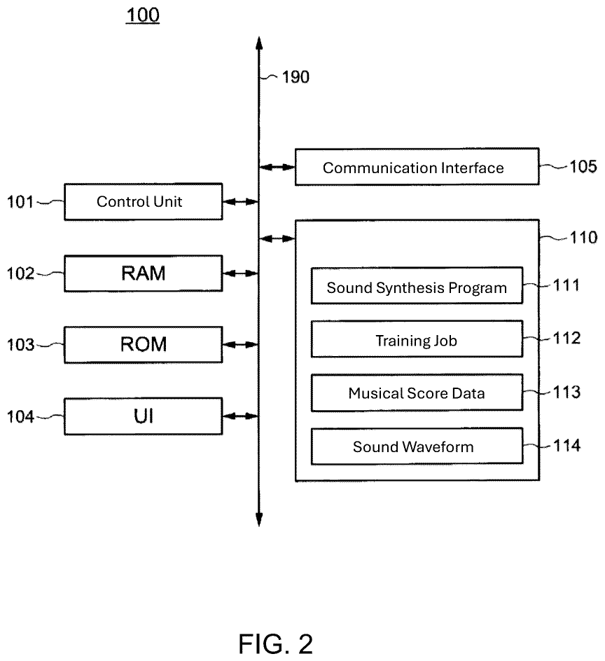

FIG. 2 is a block diagram showing the configuration of a cloud server. As shown in FIG. 2, the server 100 comprises a control unit (electronic controller) 101, random access memory (RAM) 102, read only memory (ROM) 103, a user interface (UI) 104, a communication interface 105, and the storage 110. The sound synthesis technology of the present embodiment is realized by cooperation between each of the functional units of the server 100.

The control unit 101 includes at least one or more processors such as a central processing unit (CPU) or a graphics processing unit (GPU), and at least one or more storage devices such as registers and memory connected to said CPU and/or GPU. The control unit 101 executes, with the CPU and the GPU, programs temporarily stored in the memory, to realize each of the functions provided in the server 100. Specifically, the control unit 101 performs computational processing in accordance with various types of request signals from the communication terminal 200 and provides the result of the processing to the communication terminals 200 and 300.

The RAM 102 temporarily stores content data, acoustic models (composed of an architecture and variables), control programs necessary for the computational processing, and the like. The RAM 102 is used, for example, as a data buffer, and temporarily stores various data received from an external device, such as the communication terminal 200, until the data are stored in the storage 110. General-purpose memory, such as static random access memory (SRAM) or dynamic random access memory (DRAM), can be used as the RAM 102.

The ROM 103 stores various programs, various acoustic models, parameters, etc., for realizing the functions of the server 100. The programs, acoustic models, parameters, etc., stored in the ROM 103 are read and executed or used by the control unit 101 as needed.

The user interface 104 is equipped with a display unit that carries out graphical displays, operators or sensors for receiving a user's operation, a sound device for inputting and outputting sound, and the like. The user interface 104, by the control of the control unit 101, displays various display images on the display unit thereof, and receives input from a user. The display unit is a display, for example, a liquid-crystal display (LCD), or a light-emitting diode (LED) display, or a touch panel.

The communication interface 105 is an interface for connecting to the network 400 and sending and receiving information with other communication devices such as the communication terminals 200, 300 connected to the network 400, by the control of the control unit 101.

The storage 110 is a recording device (storage medium) capable of permanent information storage and rewriting, such as nonvolatile memory or a hard disk drive. The storage 110 stores information such as programs, acoustic models, and parameters, etc., required to execute said programs. As shown in FIG. 2, the storage 110 stores a sound synthesis program 111, a training job 112, musical score data 113, and a sound waveform 114. For example, the sound synthesis program P1, the training program P2, the musical score data D1, and the audio data D2 disclosed in International Publication no. 2022/080395 can be respectively used as these programs and data. The sound waveforms 114 stored in the storage 110 include training sound waveforms used to train the acoustic model 120 in the past. In this manner, data pertaining to training sound waveforms used for training in the past can be referred to as “history data.”

As described above, the sound synthesis program 111 is a program for generating synthetic sound waveforms from musical score data or sound waveforms. When the control unit 101 executes the sound synthesis program 111, the control unit 101 uses an acoustic model 120 to generate a synthetic sound waveform. The synthetic sound waveform corresponds to the audio data D3 disclosed in International Publication no. 2022/080395. The program is a training process executed by the training program for the acoustic model 120 executed by the control unit 101 in the training job 112, for example, the program for training an encoder and an acoustic decoder disclosed in International Publication no. 2022/080395. The musical score data are data that define a musical piece. The sound waveform is waveform data representing a singer's singing voice or a performance sound of a musical instrument. The configurations of the communication terminals 200 and 300 are basically the same as that of the server 100 with some differences in their scale, etc.

### 1-3. Acoustic Model Used for Sound Synthesis

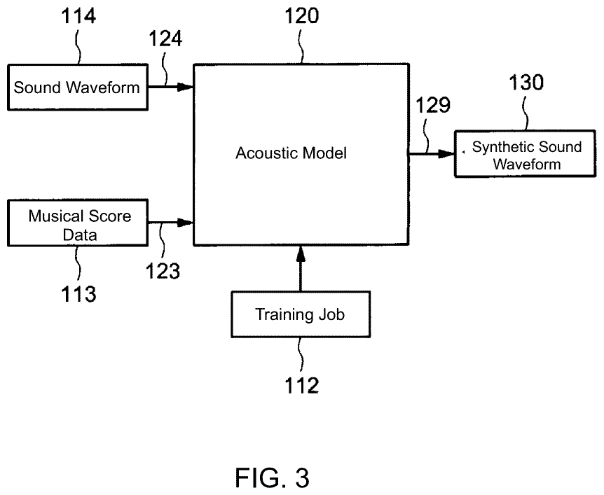

FIG. 3 is an explanatory diagram of an acoustic model. As described above, the acoustic model 120 is a machine learning model used in a sound synthesis process executed by the control unit 101 of FIG. 2, when the control unit 101 reads and executes the sound synthesis program 111. The acoustic model 120 is trained to generate acoustic features. Musical score features 123 of the musical score data 113 or acoustic features 124 of the sound waveform 114 of a desired musical piece are input to the acoustic model 120 as an input signal by the control unit 101. The control unit 101 processes the sound source ID and the musical score features 123 using the acoustic model 120, thereby generating acoustic features 129 of the synthesized sound of the musical piece. Based on the acoustic features 129, the control unit 101 synthesizes the musical piece with the synthetic sound waveform 130 sung by the singer or played by a musical instrument specified by the sound source ID, and outputs the synthesized result. Alternatively, the control unit 101 processes the sound source ID and the musical score features 124 using the acoustic model 120, thereby generating acoustic features 129 of the synthesized sound of the musical piece. Based on the acoustic features 129, the control unit 101 synthesizes and outputs the synthetic sound waveform 130, in which the sound waveform of the musical piece is converted to the timbre of the singing of the singer or the performance sound of the musical instrument specified by the sound source ID.

The acoustic model 120 is a generative model established by machine learning. The acoustic model 120 is trained by the control unit 101 executing a training program (i.e., executing the training job 112). The control unit 101 uses (an unused) new sound source ID and a sound waveform for training to train the acoustic model 120 and determines the variables of the acoustic model 120 (at least the acoustic decoder). Specifically, the control unit 101 generates acoustic features for training from the sound waveform for training, and when a new sound source ID and acoustic features for training are input to the acoustic model 120, the control unit 101 gradually and repeatedly changes said variables such that the acoustic features for generating the synthetic sound waveform 130 approach the acoustic features for training. The sound waveform for training can be uploaded (transmitted) to the server 100 from the communication terminal 200 or the communication terminal 300 and stored in the storage 110 as user data, or can be stored in the storage 110 in advance by an administrator of the server 100 as reference data. In the following description, storing in the storage 110 can be referred to as storing in the server 100.

### 1-4. Sound Synthesis Method

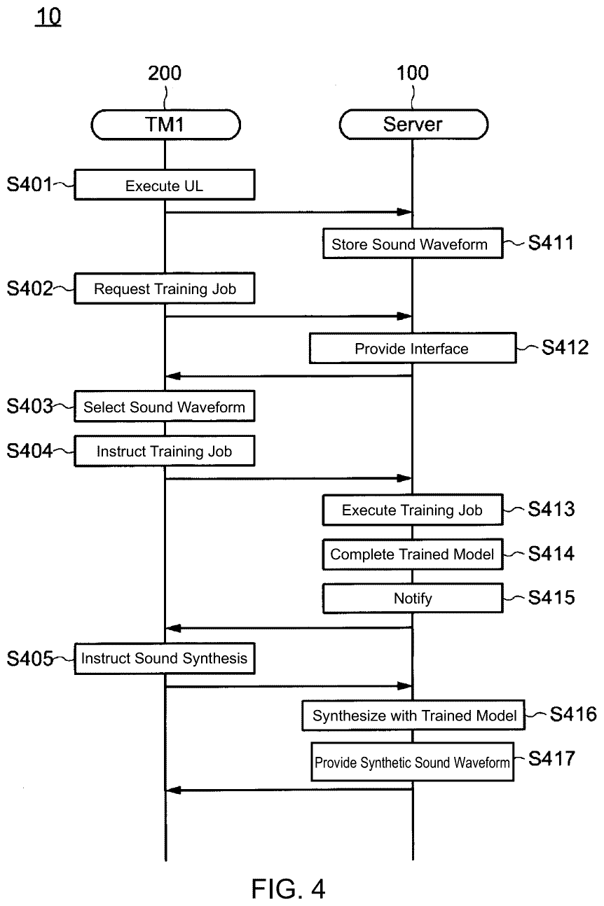

FIG. 4 is a sequence diagram showing an acoustic model training method. In the acoustic model training method shown in FIG. 4, the communication terminal 200 uploads a sound waveform for training to the server 100, for example. However, as described above, the sound waveform for training can be pre-stored in the server 100 by other means. In practice, each step of the process TM1 on the communication terminal 200 side is executed by a control unit (electronic controller including at least one or more processors) of the communication terminal 200 and each step of the process on the server 100 side is executed by the control unit 101 of the server 100; however, in order to simplify the description, the communication terminal 200 and the server 100 will be described as executing each of the steps. The same applies to the explanation of the subsequent flowcharts; however, since it is not at all important in this disclosure to distinguish between a communication terminal and a server as the executing entity, with respect to the flowcharts, a system that includes the communication terminals 200, 300 and the server 100 will basically be described as executing the steps.

As shown in FIG. 4, first, the communication terminal 200 uploads (transmits) one or more sound waveforms for training to the server 100, based on an instruction from a creator that has logged in to a user's account on the server 100 (S401). The server 100 stores the sound waveform for training transmitted in S401 to the user's storage area (S411). One or more sound waveforms can be uploaded to the server 100. The plurality of sound waveforms can be separately stored in a plurality of folders in the user's storage area. Steps S401, 411 described above are steps relating to preparation for executing the following training job. The sound waveform stored in S411 can be referred to as a “sound waveform relating to the training of the acoustic model” or a “sound waveform used for training.” Data relating to these sound waveforms can be referred to as “history data relating to the input sound waveforms.” Of the sound waveforms described above, a sound waveform used for a training job can be referred to as a “sound waveform used for training.”

Steps for executing a training job will be described next. The communication terminal 200 requests the server 100 to execute a training job (S402). In response to the request made in S402, the server 100 provides the communication terminal 200 with a graphical user interface (GUI) for selecting, from among pre-stored sound waveforms or sound waveforms that are planned to be stored, sound waveforms to be used for the training job (S412).

In response to an input of a creator (user) to the GUI provided in S412, the communication terminal 200 displays, on a display unit for the UI thereof, the GUI provided in S412. The creator uses the GUI to select, as a waveform set for training, one or more sound waveforms from among a plurality of sound waveforms that have been uploaded to the storage area (or a desired folder) (S403).

After the waveform set (sound waveform for training) is selected in S403, the communication terminal 200 instructs the start of execution of the training job in response to an instruction from the creator (S404). The server 100 starts the execution of the training job using the selected waveform set in accordance with the instruction (S413).

Not all of the waveforms in the selected waveform set are used for training; rather, a preprocessed waveform set that includes only useful sections and excludes silent sections and noise sections is used. An acoustic model in which the acoustic decoder is untrained can be used as the acoustic model 120 (model specified as the base) to be trained. However, by selecting and using, as the acoustic model 120 to be trained, an acoustic model containing an acoustic decoder that has learned to generate acoustic features that are similar to the acoustic features of waveforms in the waveform set, from among the plurality of the acoustic models 120 already subjected to basic training, it is possible to reduce the time and cost required for the training job. Regardless of which acoustic model 120 is selected, a musical score encoder and an acoustic encoder that have been subjected to basic training are used.

The base model can be automatically determined by the server 100 from among a plurality of trained acoustic models and an initial model based on the waveform set selected by the creator, or be determined based on an instruction from the user. For example, when instructing the server 100 to start the execution of a training job, the communication terminal 200 can set, as the base model, any one model selected by the creator (user) from among a plurality of the trained acoustic models 120 and the initial model, and transmit designation data indicating the selected base model to the server 100. The server designates the acoustic model 120 to be trained based on the designation data. An unused new sound source ID is used as the sound source ID (for example, singer ID, instrument ID, etc.) supplied to the acoustic decoder. Here, the user, including the creator, does not necessarily need to know which sound source ID has been used as the new sound source ID. However, when performing sound synthesis using a trained model, the new sound source ID is automatically used. A new sound source ID forms key data for synthesizing, with an acoustic model trained by the user, acoustic features of the timbre learned in that training.

In a training job, unit training is repeated, in which partial short waveforms are extracted little by little from a preprocessed waveform set, and the extracted short waveforms are used to train the acoustic model (at least the acoustic decoder). In unit training, the new sound source ID and the acoustic features of the short waveform are input to the acoustic model 120, and the variables of the acoustic model are adjusted accordingly so as to reduce the difference between the acoustic features output by the acoustic model 120 and the acoustic features that have been input. For example, backpropagation method is used for the adjustment of the variables. Once training using a preprocessed waveform set is completed by repeating unit training, the quality of the acoustic features generated by the acoustic model 120 is evaluated, and if the quality does not meet a prescribed standard, the preprocessed waveform set is used to train the acoustic model again. If the quality of the acoustic features generated by the acoustic model 120 meets the prescribed standard, the training job is completed, and the acoustic model 120 at that time point becomes the trained acoustic model 120.

When the training job is completed in S413, the trained acoustic model 120 is established (S414). The server 100 notifies the communication terminal 200 that the trained acoustic model 120 has been established (S415). The steps S403 to S415 described above are the training job for the acoustic model 120.

After the notification of S415, the communication terminal 200 transmits, to the server 100, an instruction for sound synthesis, including the musical score data of the desired musical piece, in accordance with an instruction from the user (S405). The user in S405 is not the creator but a user of the acoustic model 120. In response, the server 100 executes a sound synthesis program, and executes sound synthesis using the trained acoustic model 120 established in S414 based on the musical score data (S416). The synthetic sound waveform 130 generated in S416 is transmitted to the communication terminal 200 (S417). The new sound source ID is used in this sound synthesis.

It can be said that, S416 in combination with S417 provides the trained acoustic model 120 (sound synthesis function) trained by the training job to the communication terminal 200 (or the user). The execution of the sound synthesis program of S416 can be carried out by the communication terminal 200 instead of the server 100. In that case, the server 100 transmits the trained acoustic model 120 to the communication terminal 200. The communication terminal 200 uses the trained acoustic model 120 that has been received to execute a sound synthesis process based on the musical score data of the desired musical piece with the new sound source ID, to obtain the synthetic sound waveform 130.

In the present embodiment, before execution of the training job is requested in S402, the sound waveform for training is uploaded in S401, but the invention is not limited to this configuration. For example, the upload of the sound waveform for training can be carried out after execution of the training job is instructed in S404. In this case, in S403, one or more sound waveforms can be selected, as the waveform set, from a plurality of sound waveforms (including sound waveforms that have not been uploaded) stored in the communication terminal 200, and, of the selected sound waveforms, sound waveforms that have not been uploaded can be uploaded in accordance with an instruction to execute a training job.

### 1-5. Method of Displaying Characteristic Distribution

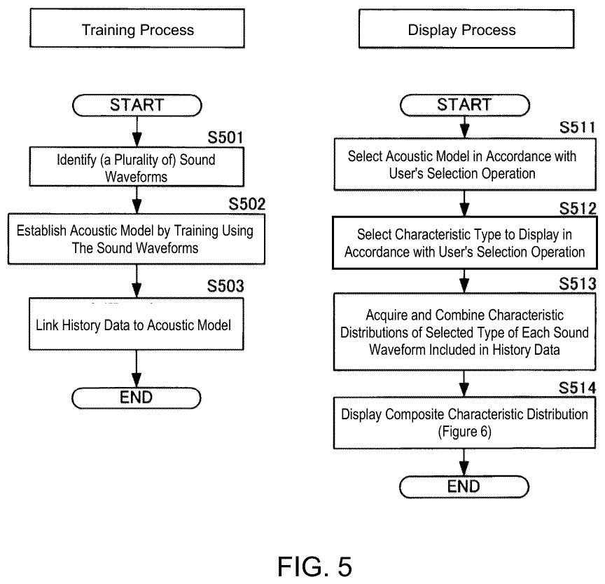

FIG. 5 is a flowchart illustrating a training process for the acoustic model 120 and a flowchart illustrating a process of displaying the characteristic distribution of the sound waveform used for training the acoustic model 120. The process of FIG. 5 is executed by the system. In the present embodiment, the sound waveform used for training is not disclosed, but the characteristic distribution of the sound waveform is disclosed and can be viewed by a third party.

In the “training process” of FIG. 5, the user selects a sound waveform from among the sound waveforms uploaded to the server 100. The system uses the selected sound waveform to execute the training job. The system (server 100) identifies a plurality of sound waveforms to be used for the training of the acoustic model 120 in accordance with the user's selection operation (S501). The system (server 100) uses the plurality of identified sound waveforms and executes a training job for the acoustic model 120 to be the base model, thereby establishing the trained acoustic model 120 (S502). Then, the system (server 100) links (associates), to the acoustic model 120, history data including identifiers of the sound waveforms used for training the established acoustic model 120 (S503). Here, the various types of data linked to the acoustic model, such as history data, are provided to a third party that acquires the acoustic model from cloud storage in association with the acoustic model. The storage can or cannot be integrated with the server 100. The third party can acquire, and confirm, an overview of the characteristic distribution of a sound waveform, etc., used for the training of the acoustic model, based on the history data (identifier). However, the sound waveforms used for the training of the acoustic model 120 themselves are protected so as not to be accessible from the communication terminals 300 of users other than the creators who uploaded the sound waveforms, to protect copyright or personal information. On the other hand, the server 100 can use the identifiers thereof to identify and acquire the sound waveforms used for the training of the trained acoustic model 120, regardless of whether the sound waveforms were uploaded by the user, for the purpose of sound waveform analysis described further below.

The system (server 100) analyzes a plurality of sound waveforms indicated by the identifiers included in the history data and acquires a characteristic distribution of a plurality of characteristics possessed by the sound waveforms. The characteristic distribution is, for example, a histogram-type distribution in which the characteristic values of the target indicating the distribution are on the x- and y-axes, and the data amount of the sound waveform at each characteristic value on the x- and y-axes is on the z-axis.

In the “display process” of FIG. 5, a user selects the acoustic model 120 and a characteristic type. The system displays the characteristic distribution of the sound waveform specified by the history data of the selected acoustic model 120 on a display unit (also referred to as the display unit of the system) for the UI of the user's communication terminal 200. The display unit of the communication terminal 20 is a display, for example, a liquid-crystal display (LCD), or a light-emitting diode (LED) display, or a touch panel. The system, in accordance with the user's selection operation of the acoustic model, selects one acoustic model 120 from among a plurality of acoustic models (S511). The system, in accordance with the user's selection operation of the characteristic type, selects the characteristic type to be displayed from among a plurality of characteristic types (S512). One or a plurality of types can be selected here.

Here, the characteristic type refers to the type of a plurality of characteristics possessed by the sound waveform used for the training of the acoustic model 120. For example, the plurality of characteristics possessed by a sound waveform (sound waveform characteristics) include pitch, intensity, phoneme, duration, and style. The user selects one or more characteristics from these characteristics by means of the selection operation described above.

The style described above includes singing style and performance style. Singing style is the way of singing. Performance style is a way of playing. Specifically, examples of singing styles include neutral, vibrato, husky, vocal fry, and growl. Examples of performance styles include, for bowed string instruments, neutral, vibrato, pizzicato, spiccato, flageolet, and tremolo, and for plucking string instruments, neutral, positioning, legato, slide, and slap/mute. For the clarinet, performance styles include neutral, staccato, vibrato, and trill. For example, the above-mentioned vibrato means a singing style or a performance style that frequently uses vibrato. The pitch, volume, timbre, and dynamic behaviors thereof in singing or playing change overall with the style.

The system (server 100) analyzes each of a plurality of sound waveforms indicated by the identifiers included in the history data to acquire the characteristic distribution of the waveform type selected in S512, and combines the characteristic distributions of the plurality of sound waveforms to obtain a single composite characteristic distribution (S513). For example, regarding sound waveforms A and B indicated by identifiers included in the history data, the system (server 100) acquires characteristic distributions A and B relating to pitch, and combines (accumulates) the data amounts of the sound waveforms A and B at each pitch. The system displays the composite characteristic distribution for the selected type (S514). The display of the characteristic distribution is one example of a display of information relating to the characteristic distribution. When two or more types are selected in S512, the system acquires the characteristic distributions for the two or more types by analyzing each sound waveform and combines the characteristic distributions of the plurality of sound waveforms for each type in S513, and displays the composite characteristic distribution for the two or more types in S514.

As described above, the server 100 displays information relating to the characteristic distributions of all sound waveforms used for the training of the acoustic model 120 selected by the user. The composite characteristic distribution described above corresponds to the ability acquired by the acoustic model 120 through the training.

In the present embodiment, an example is shown in which the characteristic type corresponding to the characteristic distribution that is displayed is selected by the user in S512, but the characteristic type can be fixed and not be selectable by the user.

If the training of S502 is carried out based on an untrained initial model, the history data of S503 include the identifiers of all the sound waveforms used in said training. On the other hand, if the training of S502 is carried out based on an existing, trained acoustic model 120, the history data of S503 include the identifiers of all the sound waveforms used for said training and the identifiers of all the sound waveforms used for the training of the acoustic model 120 which served as the base model. Regardless of whether the base model is an initial model, attribute data linked to the trained acoustic model 120 include the identifiers of all the sound waveforms used for all the training that took place until the acoustic model 120 was established from the initial model (all the sound waveform used for training the acoustic model).

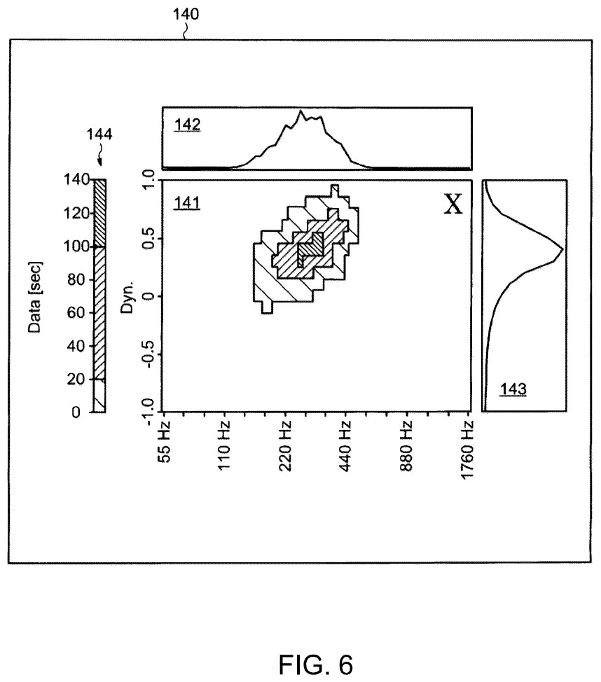

FIG. 6 shows one example of a characteristic distribution displayed in S514 of FIG. 5. In the present embodiment, two characteristic types, “pitch” and “intensity,” are selected in S512. A screen 140 in FIG. 6 displays a graph indicating the characteristic distribution of “pitch” and “intensity” synthesized for a plurality of sound waveforms included in the history data.

The screen 140 shown in FIG. 6 is provided by the system (server 100) and displayed on the display unit of the system (communication terminal 200). The screen 140 includes a two-dimensional display section 141, a first axis display section 142, a second axis display section 143, and a data amount bar 144.

The first axis display section 142 displays a curve indicating the data amount of the sound waveform with respect to each value of a first characteristic on the first axis. Since the first characteristic in the present embodiment is pitch, the unit of the first axis is [Hz]. The second axis display section 143 displays a curve indicating the data amount of the sound waveform with respect to each value of a second characteristic on the second axis. Since the second characteristic in the present embodiment is intensity (volume), the unit of the second axis is [Dyn.].

The two-dimensional display section 141 is a two-dimensional distribution of the data amount in a Cartesian coordinate system using the first and second axes. In the two-dimensional display section 141, the data amount of the sound waveform at each value on the first and second axes is displayed in a manner corresponding to divisions of the data amount. The data amount bar 144 indicates a scale in a manner corresponding to the divisions of the data amount.

In the example shown in FIG. 6, the data amount of the sound waveform is divided into a first division of 0 [sec], a second division of greater than 0 [sec] and less than or equal to 20 [sec], a third division of greater than 20 [sec] and less than or equal to 100 [sec], and a fourth division of greater than 100 [sec] and less than or equal to 140 [sec]. The first to the fourth divisions are each displayed in a different manner. For example, these divisions can be displayed in different colors. For example, the first division can be displayed in “black,” the second division displayed in “blue,” the third division displayed in “green,” and the fourth division displayed in “yellow.” Alternatively, the first division can be displayed in “black,” the second division displayed brighter than said black, the third division displayed brighter than the second division, and the fourth division displayed brighter than the third division. More or fewer divisions can be displayed using more or fewer aspects. Not limited to color or difference in brightness, different divisions can be expressed by differences in hatching, shapes, amount of blur, etc.

As described above, according to the acoustic model training system 10 of the present embodiment, a graph is displayed indicating a characteristic distribution corresponding to sound waveforms used for the training of the current acoustic model 120 or to sound waveforms that are candidates to be used for the training of the acoustic model 120, thereby making it easy for the user to identify a training sound waveform to be used for training.

### 1-6. Modified Examples

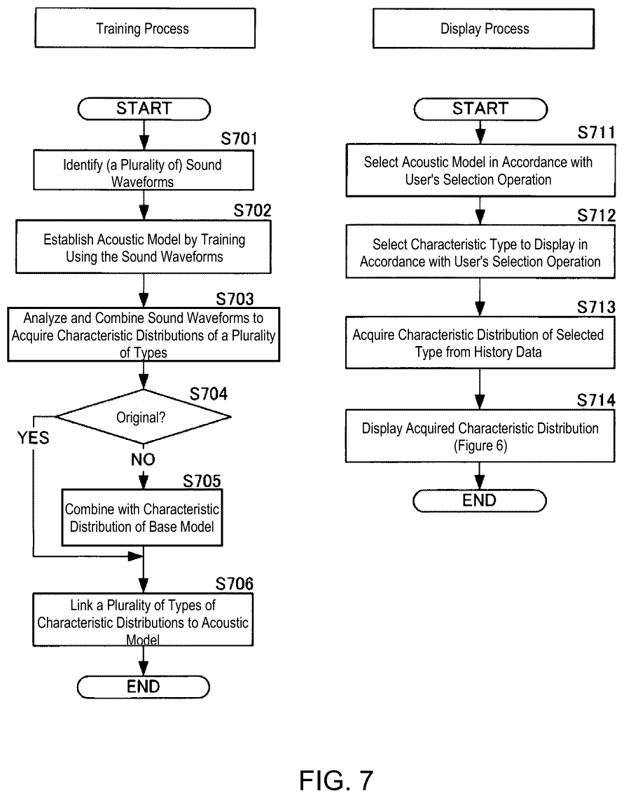

FIG. 7 is a flowchart illustrating a method for displaying a characteristic distribution of a sound waveform that is similar to the display method of FIG. 5. In the following description, descriptions of portions similar between the two are omitted, and portions that are different will be mainly described.

In the “training process” of FIG. 7, the user selects a sound waveform in the same manner as in FIG. 5. The system uses the selected sound waveform to execute the training job. Steps S701 and S702 in FIG. 7 are the same as S501 and S502 in FIG. 5. After establishing the trained acoustic model 120 in S702, the system (server 100) analyzes each of a plurality of sound waveforms used for the training thereof to acquire a plurality of types of characteristic distributions, and combines the characteristic distributions for each type to acquire a plurality of types of composite characteristic distributions (S703). Subsequently, the system (server 100) determines whether the acoustic model on which the training of S702 is based is an untrained initial model (S704).

If it is determined in S704 that the base model is not an initial model (“No” in S704), the system (server 100) combines, for each type, the plurality of types of characteristic distributions acquired in S703 and the plurality of types of characteristic distributions indicated by the history data of the trained acoustic model on which the training is based (S705). After combining, the system (server 100) links, as history data, the plurality of types of characteristic distributions composited in S705 to the acoustic model 120 established in S702 (S706). On the other hand, if it is determined in S704 that the base model is an initial model (“Yes” in S704), the system (server 100) skips the process of S705, and links, as history data, the plurality of types of characteristic distributions acquired in S703 to the acoustic model 120 established in S705.

In both display processes of FIGS. 5 and 7, the history data are used to obtain the characteristic distribution of all the sound waveforms used for the training of the trained acoustic model 120. The history data linked to the acoustic model 120 in S503 of FIG. 5 are identifiers indicating all the sound waveforms used for the training thereof. In the display process of FIG. 5, the system analyzes each sound waveform indicated by the identifiers, and acquires and combines the characteristic distribution of the sound waveforms (S513). In contrast, in the training process of FIG. 7, the system links to the trained acoustic model 120, as history data, a plurality of types of composite characteristic distributions of all the sound waveforms used for the training of the acoustic model 120 (S706). Accordingly, in the display process of FIG. 7, the system acquires, with respect to the acoustic model 120, the characteristic distribution of the selected type (S713) and displays the characteristic distribution on the screen (FIG. 6) (S714), without analyzing any sound waveform.

In any of the present embodiments, a third party can acquire and view the characteristic distribution for each acoustic model 120.

The “display process” of FIG. 7 is the same as that of FIG. 5 except for the point described above, and thus the description thereof is omitted. That is, S711 to S714 is basically the same process as S511 to S514.

### 2. Second Embodiment

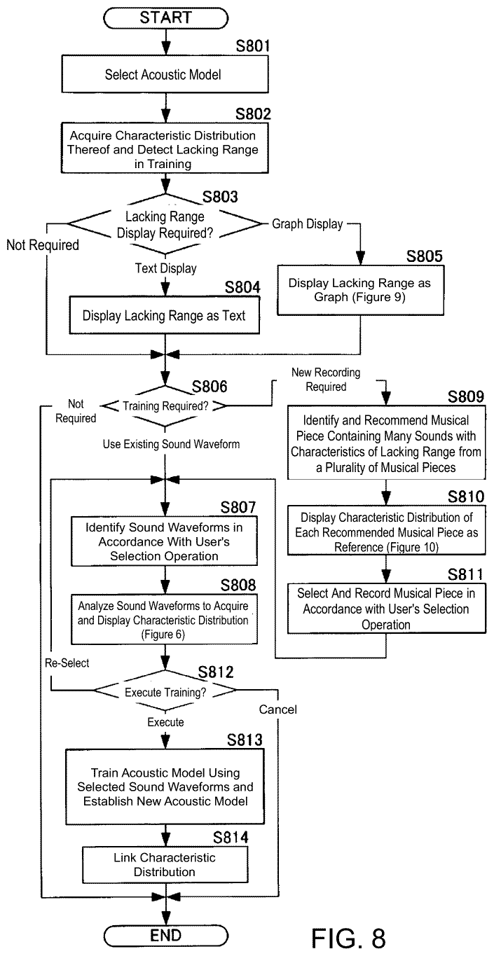

An acoustic model training system 10A according to a second embodiment will be described with reference to FIGS. 8 to 13. The overall configuration of the acoustic model training system 10A and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 4 will be referenced, and the alphabet “A” will be added after the reference symbols indicated in these figures.

### 2-1. Acoustic Model Training Process

FIG. 8 is a flowchart illustrating a training process for an acoustic model executed by the system 10A. In the acoustic model training process shown in FIG. 8, a configuration will be described in which a range where training data are lacking for a specific characteristic distribution is detected, and data suitable for compensating for said range are used to execute training.

The system (server 100) selects an acoustic model 120A and one or more characteristic types in accordance with an instruction from a communication terminal 200A (or a user) (S801). The system (server 100) acquires the selected type of characteristic distribution of the selected acoustic model 120A, and detects a lacking range in the training of the acoustic model 120A (S802). Specifically, the system acquires history data linked to the selected acoustic model 120 and acquires the selected type of characteristic distribution of the sound waveform used for training the acoustic model, based on said history data.

With respect to each type of characteristic distribution that is acquired, the system (server 100) detects a range with a data amount smaller than a threshold value, from among a range of characteristic values deemed requiring training for said type (required range), as a lacking range for that type. Alternatively, the system can compare each type of characteristic distribution that is acquired with a reference distribution of characteristic values for that type (reference distribution), and detect, as a lacking range, a range in which the characteristic distribution of that type is smaller than the reference distribution. The required range and threshold value or the reference distribution for each type can be determined based on the characteristic distribution of that type of a given musical piece, etc., selected by the user, for example, or be determined based on the characteristic distribution of that type of an existing trained acoustic model.

When a lacking range is detected in S802, the system inquires the user whether it is necessary to display the lacking range on the screen 140 (FIG. 6) (S803). This inquiry includes inquiring whether the lacking range should be carried out by displaying text (text display button) or be carried out by displaying a graph (graph display button). If the user selects text display (by operating the text display button), the system displays the lacking range on the screen as text (S804).

On the other hand, if the user selects graph display (by operating the graph display button), the system displays the lacking range on the screen as a graph (S805). If the user determines that a display of the lacking range is not required (when neither the text display button nor the graph display button is operated), the system does not carry out the display of S804 and S805 and proceeds to the subsequent step (S806).

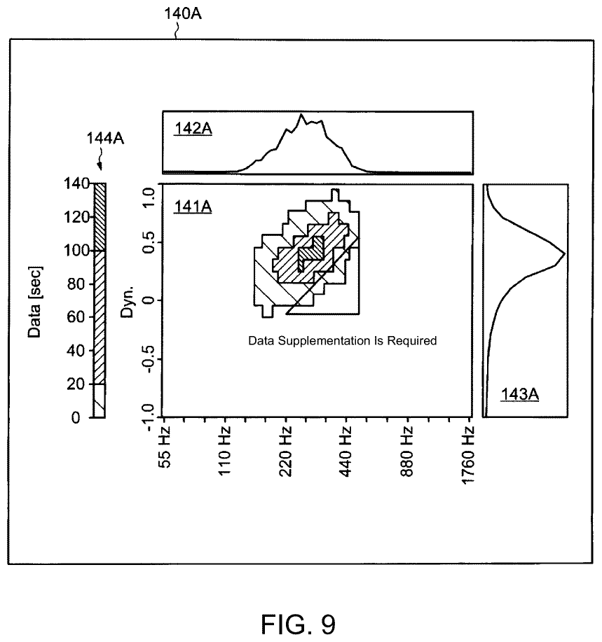

One example of the graph display of S805 is shown in FIG. 9. As shown in FIG. 9, the detected lacking range of the acoustic model 120A is displayed surrounded by a frame. In this example, the lacking range was, by coincidence, triangular, so the lacking range is surrounded by a triangular frame. The user can confirm, from this frame, the upper and lower limits of the lacking range in the first characteristic (pitch) and the second characteristic (intensity). In the present embodiment, both the upper and lower limits of the lacking range are displayed; however, it is acceptable to display only one of the upper and lower limits.

A screen 140A shown in FIG. 9 is provided by a system (server 100A) and displayed on the display unit of a system (communication terminal 200A). In the characteristic distribution shown in FIG. 9, data are lacking in the high-pitch and low-intensity ranges, so that in the screen 140A, a message (“data supplementation is required”) is displayed to notify the user of the lacking range.

The screen 140A and the message shown in FIG. 9 are merely an example and can be displayed in other manners. The system can, in S804, display information pertaining to the lacking range (for example, the pitch or intensity included in the lacking range) on the display unit as text. Alternatively, the system can display an expression of the sound signal that is lacking (staccato, vibrato, etc.).

Following S804 and S805 of FIG. 8, the system inquires the user whether it is necessary to train the acoustic model 120A (S806). This inquiry includes inquiring whether to use an existing sound waveform to carry out training (train button) or whether it is necessary to newly record a sound waveform to use for training (record & train button).

If the user selects to use an existing sound waveform (by operating the train button), the system (server 100A) selects a sound waveform from among sound waveforms that are already uploaded and stored on the server 100A in accordance with the user's waveform selection operation, and identifies the same as the sound waveform to be used for training (S807). Then, the system (server 100A) analyzes the sound waveform used for training, acquires the characteristic distribution for one or more characteristics possessed by the sound waveform, and displays the characteristic distribution as is, if the base is an initial model, and after combining with the characteristic distribution of the base acoustic model, if the base is not an initial model, on the display unit of the communication terminal 200 in the same manner as shown in FIG. 6, for example (S808).

On the other hand, if the user selects to newly record a sound waveform (by operating the record & train button) in response to the above-mentioned inquiry, the system (server 100A) identifies, from among a plurality of musical pieces, a musical piece that sufficiently contains sounds with characteristic values in the lacking range, and recommends the musical piece to the user (S809). That is, the system detects, from among a plurality of musical pieces, one or more candidate musical pieces that contain one or more notes each of which has a characteristic value within the lacking range, and presents the detected candidate musical pieces to the user. In the case of the present embodiment, the system analyzes a plurality of notes included in the musical score data of a musical piece disclosed in advance (before the training process shown in FIG. 8 is started), and acquires the characteristic distribution of sound signals to be played in the musical piece (referred to as the characteristic distribution of the musical piece).

When recommending musical pieces to the user, the system displays, as reference, the characteristic distribution of each recommended musical piece in the same manner as shown in FIG. 6, for example (S810). When there is a plurality of musical pieces to recommend, the system can display the plurality of characteristic distributions of the plurality of musical pieces at once, or display the characteristic distribution of each musical piece individually. The characteristic distribution displayed in S810 is the characteristic distribution of the musical piece based on the musical score data of the musical piece corresponding to said characteristic distribution.

The sound waveform of the musical piece recommended in S809 is a sound waveform recorded prior to the training of the acoustic model 120A, and a sound waveform that is planned to be used (or that could be used) for the training thereof.

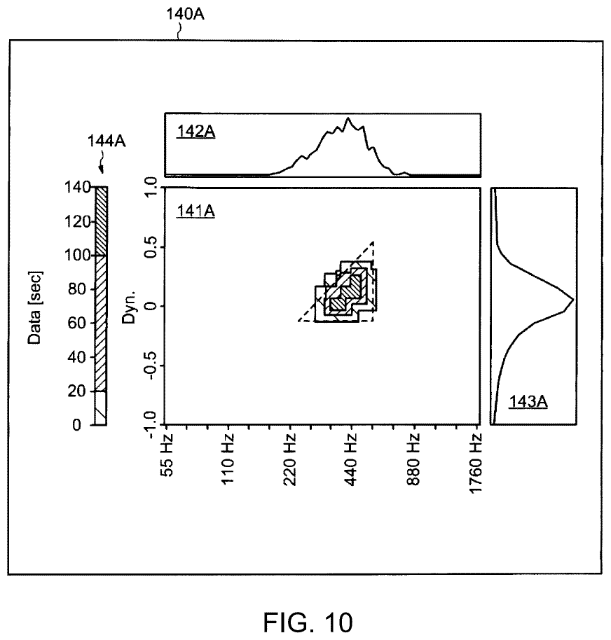

FIG. 10 shows one example of a screen of the characteristic distribution of the musical piece displayed in S810. On the screen in FIG. 10, a lacking range similar to that in FIG. 9 is shown by a dotted line as reference. For example, the system (server 100A) identifies, from among analyzed musical pieces, a musical piece having sufficient data amount in the lacking range as a musical piece to be recommended. The characteristic distribution of FIG. 10 is a characteristic distribution of only sound signals of one musical piece. Accordingly, the data amount of the characteristic distribution of FIG. 10 is considerably smaller than the data amount of the characteristic distribution of all sound waveforms used for the training of the acoustic model 120, such as that shown in FIG. 6.

The user selects and plays, for example one musical piece, from among the musical pieces recommended in S809 and S810. The system (communication terminal 200) records the musical piece that is played (S811), and transmits the recording data (new sound waveform) to the server 100A. The system (server 100A) stores the new sound waveform in the user's storage area, in the same manner as the existing sound waveforms. Subsequently, a sound waveform selection process is carried out in S807.

A characteristic distribution of the new sound waveform recorded by a user in S811 does not necessarily match the characteristic distribution of the musical score data of said musical piece. The characteristic distribution of the entire new sound waveform does not necessarily match with the characteristic distribution of FIG. 10. The system (server 100A) selects sound waveforms to be used for training from among existing sound waveforms and the new sound waveform (S807) and analyzes the sound waveforms to be used for training to acquire the characteristic distribution thereof (S808). For example, when training of the acoustic model 120A in step S812 is an additional training of the acoustic model 12A, the system (server 100A), in step S808, analyzes the plurality of sound waveforms that have been used for previous training of the acoustic model 12A executed before the additional training, and the sound waveform that is additionally (newly) used for the additional training, to acquire the characteristic distribution. The characteristic distribution acquired here is, with respect to the acoustic model 120A expected to be established by a future training that uses the sound waveform, the characteristic distribution of the sound waveform to be used in said future training. In S808, the system displays the characteristic distribution of all the sound waveforms used for training the expected trained acoustic model 120A. If the base model of the training is a trained acoustic model, a characteristic distribution obtained by combining the characteristic distribution of the base model and the characteristic distribution of said expected acoustic model 120 is displayed. The user can look at this characteristic distribution and determine whether the sound waveform specified in S807 is appropriate.

If the user responds to the inquiry in S806 that training is not desired (by operating a training not required button), the flow shown in FIG. 8 ends.

Subsequent to S808, the server 100A inquires the user whether it is necessary to execute training of the acoustic model 120A (S812). If the user operates an execute training button in response to said inquiry to instruct execution of training that uses the sound waveform selected in S807, the system (server 100A) executes the training of the acoustic model 120A selected in S801 using the sound waveform selected in S807, in the same manner as in S502, to establish the trained acoustic model 120A (S813). The system (server 100A) acquires the characteristic distribution of all sound signals used for the training of the established acoustic model 120 and links the characteristic distribution to the acoustic model 120A as history data, in the same manner as in S703 to S706 (S814).

On the other hand, if the user instructs re-selection of a sound waveform (by operating a sound waveform re-selection button) in response to the above-mentioned inquiry, the system (server 100A) provides the user again with a GUI for selecting a waveform, and identifies a sound waveform in accordance with the user's selection operation, as shown in S807.

If the user instructs canceling the execution of the training (by operating a cancel training button) in response to the inquiry in S812, the system ends the process shown in FIG. 8.

In S812, the system can inquire the user whether a new recording is necessary. If the user instructs to newly record a sound waveform (by operating the record & train button) in response to the inquiry, the process after S809 to S811 described above is carried out.

In S809, the system can recommend a new musical piece based on a musical piece used in the past for the training of the acoustic model 120A. For example, the system can recommend a different musical piece performed by the same singer or performer as a musical piece already used for training. The system can recommend a musical piece in the same or similar genre as a musical piece used for training. Furthermore, the system can recommend an entire musical piece or a portion of a musical piece.

As described above, according to the acoustic model training system 10A of the present embodiment, the user can efficiently prepare or select a training sound waveform that is suitable for regions lacking in training in the current acoustic model 120A, and to recommend, to the user, musical pieces suitable for supplementing data in said regions.

### 3. Third Embodiment

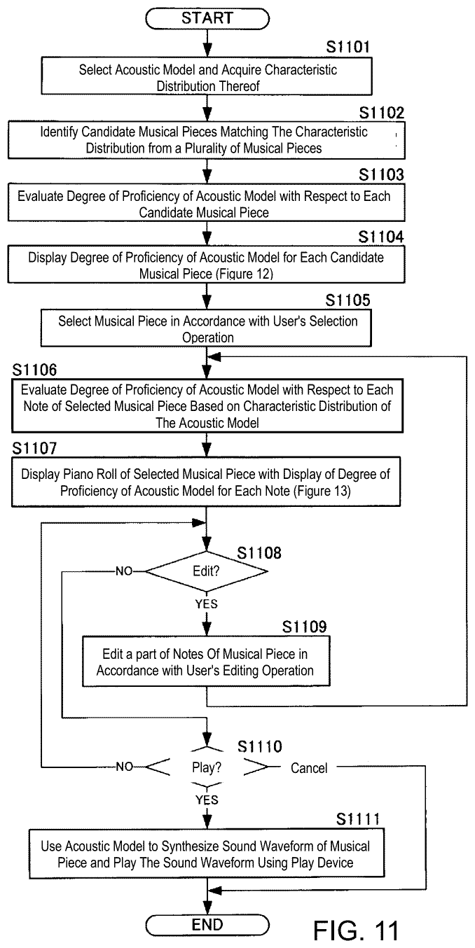

An acoustic model training system 10B according to a third embodiment will be described with reference to FIG. 11. The overall configuration of the acoustic model training system 10B and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 4 will be referenced, and the alphabet “B” will be added after the reference symbols indicated in these figures.

### 3-1. Selecting, Editing, and Playing a Musical Piece

FIG. 11 is a flowchart executed by the system 10B, illustrating a process of selecting, editing, and playing a musical piece, which allows a user to select, edit, and play a desired musical piece. In FIG. 11, a configuration is described in which the degree of proficiency of an acoustic model 120B is evaluated based on the characteristic distribution of the acoustic model 120B, and the degree of proficiency is displayed to a user.

A system (server 100B) selects an acoustic model 120B from among a plurality of trained acoustic models in response to a user's selection instruction, and acquires the characteristic distribution of the acoustic model 120B based on linked history data (S1101). Subsequently, the system (server 100B) identifies, from among a plurality of musical pieces, one or more candidate musical pieces that are likely to match the characteristic distribution acquired in S1101 (S1102), and evaluates the degree of proficiency of the acoustic model 120B for each candidate musical piece (S1103).

Each acoustic model 120B is a model obtained from an initial model through training using sound waveforms of a plurality of first musical pieces, and in at least in some of said training, the training is carried out using a sound waveform of performance sounds of the first musical piece and a musical score corresponding to said sound waveform. That is, the acoustic model 120B is a model trained using training data that include musical score features of at least a part of the musical score of the sound waveform of the first musical piece used for training in the past, and first acoustic features of said sound waveform. When a musical score of an unknown second musical piece (that has not been used for training) is input to this acoustic model 120B, the acoustic model 120B generates acoustic features (second acoustic features) of the second musical piece corresponding to the musical score features of said second musical piece.

In S1101, the system (server 100B) acquires history data representing the history of all the sound waveforms of the first musical piece used for the training of the selected acoustic model 120B. As described with respect to the first embodiment, history data linked to the acoustic model 120B can include identifiers of all the sound waveforms, or the characteristic distribution of all the sound waveforms. The system (server 100B) acquires the characteristic distribution of all the sound signals as the characteristic distribution of the acoustic model 120B based on said history data. The characteristic distribution acquired here is the distribution of any one or more prescribed, or user-specified, characteristics, from among a plurality of characteristics of the sound signal. The system can display the characteristic distribution of the acoustic model on the display unit of the communication terminal 200B. In the present Specification, the musical score data can be referred to as a “musical score.”

Musical score data of a plurality of musical pieces are provided in the system. In S1102, the system analyzes each of the plurality of musical pieces, acquires the characteristic distributions of the musical pieces, and selects, from among the plurality of musical pieces, musical pieces whose characteristic distribution deviates little from the characteristic distribution of the acoustic model 120B, thereby identifying said musical pieces as candidate musical pieces (also referred to as recommended musical pieces) that are likely to match the acoustic model 120. Alternatively, in S1102, the system can detect the highest and lowest notes of each of the plurality of musical pieces, select one or more musical pieces for which the characteristic distribution of the acquired acoustic model 120B includes the highest and lowest notes thereof, and identify said musical pieces as candidate musical pieces that are likely to match the acoustic model 120B.

The degree of proficiency with respect to a musical piece to be performed is evaluated based on the acquired characteristic distribution and the musical score data of the musical piece. Specifically, the degree of proficiency is the degree to which the characteristic distribution of the acoustic model 120B covers the characteristics of the musical score data. The characteristic distribution of the acoustic model 120B covering the characteristics of the musical score data means that the characteristics of the acoustic model 120B are distributed within the range in which the characteristics of sound signals based on the musical score data are distributed, that is, that the sound signals in that range have already been learned by the acoustic model 120B. For example, when both characteristic distributions are superimposed, if the characteristic distribution of the musical score data is present inside the characteristic distribution of the acoustic model, the degree of proficiency is 100%.

Furthermore, the degree of proficiency can be evaluated based on the data amount of the characteristic distribution of the acoustic model 120B for each characteristic value in the range in which the characteristics of the musical score data are distributed. Specifically, the degree of proficiency can refer to the percentage of characteristic values within that range for which the data amount in the characteristic distribution exceeds a prescribed amount (for example, 40 seconds). For example, if the percentage of characteristic values for which the data amount in the characteristic distribution of acoustic model 120B exceeds the prescribed amount is 80% across all characteristic values in the characteristic distribution range of the music score data, then the degree of proficiency (coverage rate) of that acoustic model is 80%.

The degree of proficiency can be represented by numerical values, a meter, or a bar graph. Alternatively, in the display of FIG. 6, the system can display the characteristic distribution of the acoustic model 120B overlapped with the characteristic distribution of the musical score data of the musical piece. The user can thereby look at the display and understand the degree of proficiency of the acoustic model with respect to the musical piece.

In S1103, the system (server 100B) evaluates the degree of proficiency of the acoustic model with respect to a second musical piece based on the musical score of the musical piece (second musical piece) identified as a candidate musical piece, and the characteristic distribution of the acoustic model 120B. The order of execution of S1102 and S1103 can be reversed. In that case, the system first evaluates the degree of proficiency for all of the plurality of prepared musical pieces in S1103, and, in the subsequent S1102, select, from among a plurality of musical pieces, one or more musical pieces for which the degree of proficiency is high and identify said musical pieces as candidate musical pieces. Alternatively, musical pieces for which the degree of proficiency is higher than a threshold value can be selected from a plurality of musical pieces, and one or more musical pieces for which the degree of proficiency is high can be identified from among the selected musical pieces as candidate musical pieces.

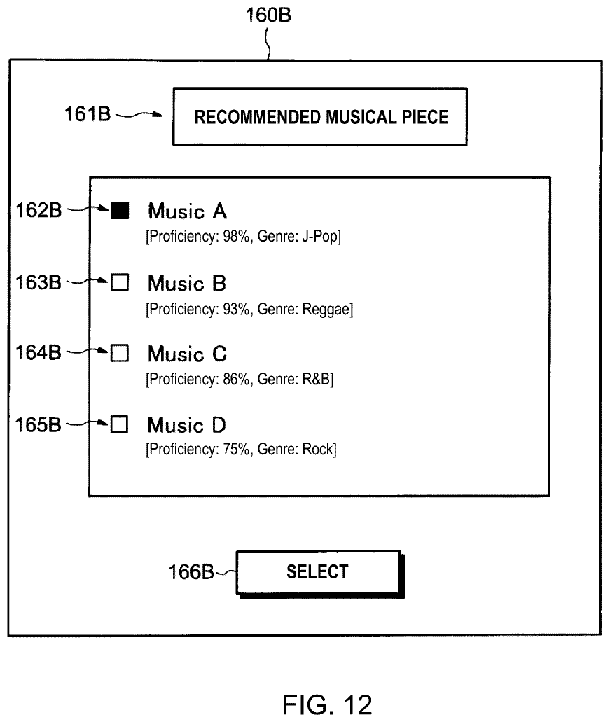

Subsequently, the system displays, in association with each candidate musical piece (recommended musical piece), the degree of proficiency of the acoustic model 120B with respect to said candidate musical piece (S1104). FIG. 12 shows one example of a display of the recommended musical piece and degree of proficiency. In this example, a plurality of second musical pieces selected based on the characteristic distribution of the acoustic model 120B are displayed in association with the degree of proficiency of the acoustic model 120B with respect to each of the musical pieces, thereby recommending said musical pieces to the user.

A GUI 160B shown in FIG. 12 is displayed on a display unit of the system (communication terminal 200B) and includes a title 161B, a display column for recommended musical pieces, and a select button 166B. The display column for recommended musical pieces displays each of the recommended musical pieces, radio buttons 162B-165B for selecting the recommended musical pieces, and additional information for the recommended musical pieces, such as the degree of proficiency and genre.

When the user selects a radio button corresponding to a desired musical piece from among the plurality of recommended musical pieces and presses the select button 166B in the GUI 160B, the system (server 100B) selects the musical piece in accordance with the user operation (S1105).

Subsequently, the system (server 100B) evaluates the degree of proficiency of the acoustic model 120B for each note of a series of notes of the musical score data of the selected musical piece based on the characteristic distribution of the acoustic model 120B (S1106), and displays, on the display unit of the system (communication terminal 200), each note of the musical piece together with the degree of proficiency with respect to said note (S1107). For example, the system can display a piano roll of the musical piece with a display of the degree of proficiency. Since the degree of proficiency is evaluated for each note, the degree of proficiency is displayed for each note in the piano roll.

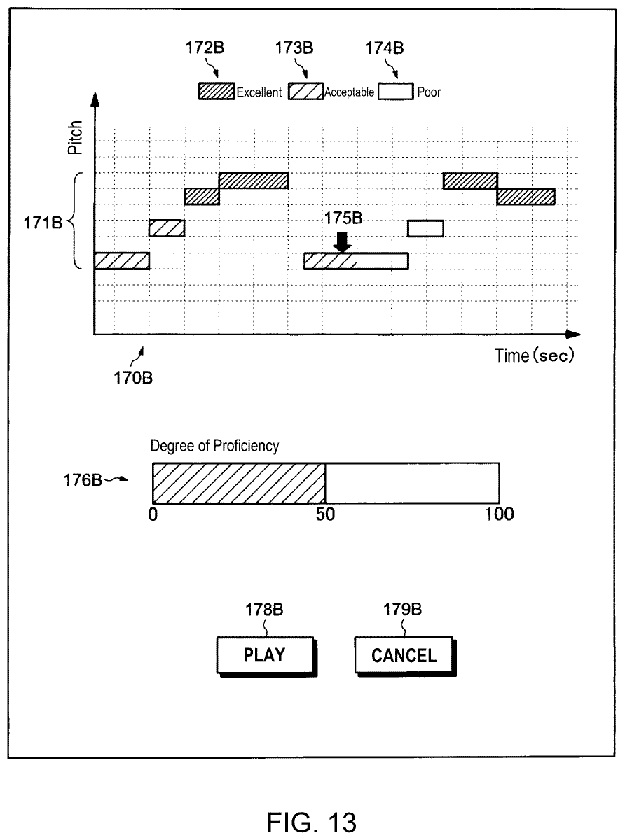

FIG. 13 shows one example of a piano roll displayed in S1107. In a piano roll 170B shown in FIG. 13, the horizontal axis is “time (sec)” and the vertical axis is “pitch.”

A plurality of note bars 171B indicating the pitch and timing of each of a series of notes of the selected musical piece are displayed in the piano roll 170B. The note bar 171B of each note is, for example, displayed in one of three modes in accordance with the degree of proficiency with respect to that note. A note bar 172B “Excellent” with dense hatching indicates that the degree of proficiency with respect to that note is high. A note bar 173B “Acceptable” with sparse hatching indicates that the degree of proficiency with respect to that note is moderate. A white note bar 174B “Poor” indicates that the degree of proficiency with respect to that note is low. That is, a note bar is displayed in one of three levels, “Excellent,” “Acceptable,” and “Poor” in order of decreasing degree of proficiency.

Here, the degree of proficiency of the acoustic model 120B is evaluated and displayed for each note. The degree of proficiency is evaluated for sections of the musical score of the notes of the musical piece (second musical piece) and is displayed for each section of notes, as shown in FIG. 13.

There are cases in which the degree of proficiency differs even if the pitch is the same if the intensity is different. FIG. 13 shows notes in which the degrees of proficiency are different despite having the same pitch, and a note in which the degree of proficiency changes midway even though the pitch remains the same. The number divisions of the degree of proficiency with respect to a musical piece is not limited to three, and can be two, four, or more. Not limited to differences in hatching, different divisions can be expressed by differences in color, brightness, shapes, amount of blur, etc.

The arrow in FIG. 13 pointing to a bar from above is a cursor 175B indicating the play position in a play operation, described further below. Furthermore, a proficiency meter 176B shown below the graph displays the degree of proficiency for the musical piece at the position of the cursor 175B. A play button 178B and a cancel button 179B are displayed below the proficiency meter 176B. The system determines whether the user has carried out an editing operation on a note bar (S1108) and whether the user has operated the play button 178B (S1110).

If the user has carried out an editing operation on any note bar (“Yes” in S1108), the server 100B edits, from among the musical score data of the musical piece, the note corresponding to that note bar in accordance with the editing operation (S1109). The editing includes changing any of the pitch, intensity, phoneme, duration, and style of that note. For example, when the user moves a note bar in the vertical direction, the pitch of the corresponding note is changed, and if the user moves a note bar horizontally, the timing of the note is changed. When the user changes the length of a note bar, the duration of the corresponding note is changed. Furthermore, the use can open a property editing screen of a note bar and change the intensity and style of the corresponding note. When the editing is carried out, the degree of proficiency with respect to the edited note is reevaluated by the processes of S1106 and S1107, and the display (display including the degree of proficiency) with respect to the note is updated.

On the other hand, if the user does not carry out editing operation on any note bar (“No” in S1108), the system determines the presence/absence of an operation on the play button in S1110. If the user operates the play button 178B (“Yes” in S1110), the server 100B uses the acoustic model 120B to synthesize a sound waveform corresponding to the musical score data of the musical piece, uses a play device to play back the synthesized sound waveform (S1111), and, when the play is completed, deletes the piano roll display and ends the process of FIG. 11. At the time of completion of play, instead of ending the process of FIG. 11, the process can proceed to S1108 with the piano roll still displayed.

The synthesis of the sound waveform described above is synthesis of a sound waveform (singing or musical instrument sounds) based on the musical score data of the musical piece obtained by the system (server 100B or communication terminal 200B). In the present embodiment, a sound waveform based on the musical score data is synthesized in S1111 after play is instructed in S1110. However, synthesis of the sound waveform can be carried out before the play instruction. for example, the synthesis of the sound waveform can be carried out at a point in time at which a musical piece is selected in S1105 or at which the musical score data are edited. In this case, a previously synthesized sound waveform is played back in accordance with a play instruction in S1110.

On the other hand, if the user does not operate the play button 178B shown in FIG. 13 (“No” in S1110), the system returns to step S1108 and determines whether editing is required. That is, if the user does not carry out an editing operation of a note bar or an operation of the play button, the server 100B enters a standby state in which the steps of S1108 and S1110 are repeated. When the user operates the cancel button 179B, the system deletes the piano roll display and ends the process of FIG. 11.

As described above, according to the acoustic model training system 10B of the present embodiment, a user can easily select a musical piece suitable for play with the acoustic model 120B, based on the characteristic distribution of the selected trained acoustic model 120. The user can confirm, in association with each note of a musical piece, the degree of proficiency of the acoustic model 120B with respect to that note. Furthermore, the user can individually edit notes of a musical piece while confirming the degree of proficiency with respect to each of a series of notes of the musical piece.

### 4. Fourth Embodiment

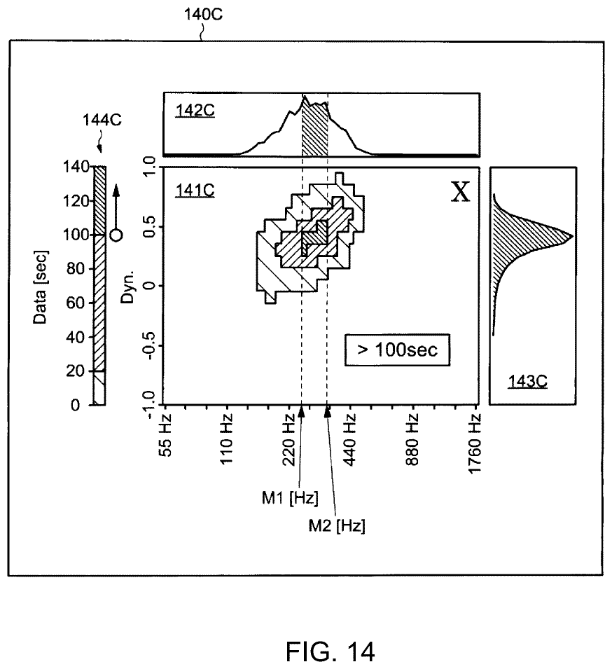

An acoustic model training system 10C according to a fourth embodiment will be described with reference to FIG. 14. The overall configuration of the acoustic model training system 10C and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 4 will be referenced, and the alphabet “C” will be added after the reference symbols indicated in these figures.

### 4-1. Method of Displaying Characteristic Distribution

FIG. 14 is one example of a characteristic distribution of a sound waveform displayed by the system 10C. The characteristic distribution shown in FIG. 14 is similar to the characteristic distribution shown in FIG. 6, but the two differ in that, among the two characteristics that constitute the display of the characteristic distribution, the former displays a distribution pertaining to one characteristic when the other characteristic is within a prescribed range.

FIG. 14 shows an example of a display of the characteristic distribution of volume in the second axis display section 143C, when the user specifies a condition that the data amount of the sound waveform corresponding to a third division is larger than 100 [sec] to limit the display of the data amount to when the pitch is within a range (M1 [Hz] to M2 [Hz]) that satisfies said condition. That is, the distribution of the volume of the sound waveform in the range (M1 [Hz] to M2 [Hz]), indicated by the diagonal lines in the first axis display section 142C, is displayed in the second axis display section 143C. In this manner, in FIG. 14, the system displays the characteristic distribution of the volume (second characteristic) of sound signals when the pitch (first characteristic) is within a prescribed range.

In the example of FIG. 14, the range of the first characteristic is determined based on the data amount of the sound waveform, but no limitation is imposed thereby. The range of the first characteristic, that is, a lower limit M1 and an upper limit M2, can each be set by the user to any value. It is acceptable to set only one of the lower limit M1 and the upper limit M2. Alternatively, the range of the second characteristic can be specified and the distribution of the first characteristic of the sound waveform in that range can be displayed.

As described above, according to the acoustic model training system 10C of the present embodiment, the user can confirm the characteristic distribution of a second characteristic of sound signals (training data) of interest with respect to a first characteristic. For example, it is possible to check which intensity levels of sound waveforms are lacking in training, in a range in which the pitch is lower than the upper limit M2. Alternatively, it is possible to check which pitch levels of sound waveforms have sufficient training, in a range in which the intensity is stronger than the lower limit M1.

### 5. Fifth Embodiment

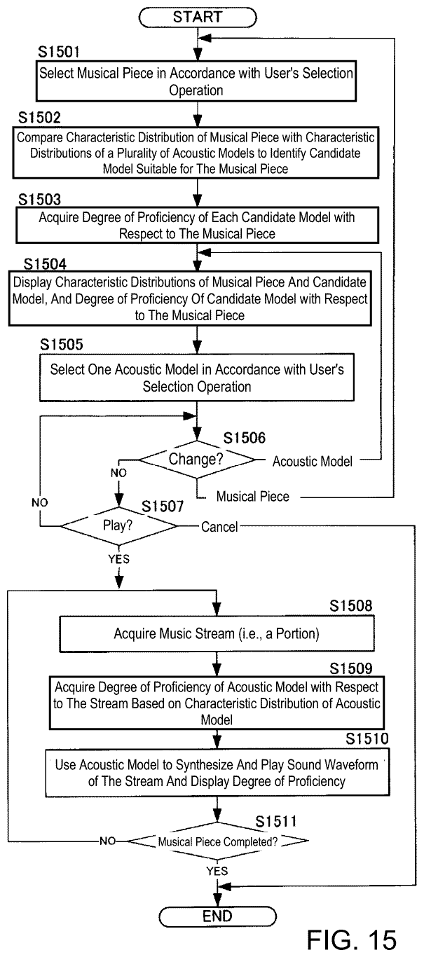

An acoustic model training system 10D according to a fifth embodiment will be described with reference to FIG. 15. The overall configuration of the acoustic model training system 10D and the block diagram relating to the server are the same as those for the acoustic model training system 10 according to the first embodiment, so the explanations thereof are omitted. In the following description, explanations of configurations that are the same as the first embodiment are omitted, and differences from the first embodiment will be mainly explained. In the following description, when describing configurations that are similar to those of the first embodiment, FIGS. 1 to 4 will be referenced, and the alphabet “D” will be added after the reference symbols indicated in these figures.

### 5-1. Real-Time Display of Proficiency

FIG. 15 is a flowchart illustrating a process of a musical piece play process. In the process shown in the flowchart of FIG. 15, an acoustic model training system 10D performs sound synthesis while sequentially receiving, from an external distribution site in the form of a music stream, portions of musical score data of a musical piece that is not yet stored on a server 100D or a communication terminal 200D. In the case of the present embodiment, the system cannot calculate in advance the degree of proficiency with respect to a series of notes in the musical piece. Accordingly, in the present embodiment, the system (server 100D) calculates in real time and displays, based on a stream received at each point in time, the degree of proficiency for each note contained in the stream.

The system 10D selects a desired musical piece from among a plurality of musical pieces in accordance with a selection operation from the communication terminal 200D (or the user) (S1501). The system (server 100D) analyzes the musical score of the selected musical piece, acquires the characteristic distribution of the musical piece, compares said characteristic distribution with the characteristic distributions of a plurality of acoustic models 120D, and identifies one or more acoustic models 120 having a characteristic distribution that can cover the characteristic distribution of the musical piece as candidate models suitable for the musical piece (S1502). That is, the system recommends an acoustic model 120D suitable for a musical piece in accordance with said musical piece. The recommended acoustic model 120D can be displayed on the display unit of the system (communication terminal 200D). Then, the system (server 100D) acquires the degree of proficiency of each candidate model with respect to the musical piece (S1503). Since the method of evaluating the degree of proficiency is carried out in the same manner as in the second embodiment (description pertaining to FIG. 11), a detailed description thereof will be omitted.

Subsequently, the system displays, on a display unit of the system (communication terminal 200D), the characteristic distribution of the musical piece and of each candidate model, and the degree of proficiency of each candidate model with respect to said musical piece (S1504). For example, the display can be such that the characteristic distribution of the musical piece and the characteristic distribution of any candidate model specified by the user are displayed as a graph, such as that shown in FIG. 6, and the degree of proficiency of the candidate model with respect to the musical piece is displayed in the form of text overlapped with, or alongside, the graph display. The graph display and the text-format display can be displayed side by side.

If a plurality of acoustic model 120D are identified as candidate models, the user refers to the characteristic distribution and the degree of proficiency displayed in S1504 and selects any one of the acoustic models 120D. The system (server 100D) selects the acoustic model 120D in accordance with the selection operation (S1505).

Subsequently, the system inquires the user whether it is necessary to change the musical piece selected in S1501 or the acoustic model 120D selected in S1505 (S1506), and whether it is necessary to play back the musical piece (S1507).

If the user instructs to change the acoustic model 120D (by operating an acoustic model selection button) in S1506, the system displays again the above-mentioned characteristic distribution and degree of proficiency on the display unit of the system (communication terminal 200D) (S1504), and selects one of the acoustic models 120D in accordance with the new selection operation carried out by the user (S1505). On the other hand, if the user instructs to change the musical piece (by operating a musical piece selection button) in S1506, the system (server 100D) selects one of the musical pieces in accordance with the new selection operation carried out by the user (S1501).

If the user does not instruct a change (without operating either selection button) in S150 (“No” in S1506), the system determines whether it is necessary to play back the musical piece (S1507). If the user instructs play of the musical piece (by operating the play button) (“Yes” in S1507), the process flow proceeds to the musical piece play step. On the other hand, if the user does not instruct play (by not operating the play button) in S1507 (“No” in S1507), the system returns to step S1606 and determines whether the above-mentioned change is necessary. That is, if the user instructs neither change nor play, the system enters a standby state in which the steps of S1506 and S1507 are repeated. As a result of the process flow looping in this manner, the user can reselect the musical piece or the acoustic model to be used before the musical piece is played back. If the user instructs cancellation in S1507, the system ends the series of process flows shown in FIG. 15.

When the user instructs play in S1507, the system (server 100D) acquires the music stream (S1508). Specifically, when the user instructs play, the system requests the musical piece to a distribution site in accordance with the play instruction operation. In response to said request, streaming distribution of the musical piece from the distribution site to the system (server 100D) is started. The streaming distribution for each part of the musical score data is continuously carried out from the beginning to the end of the musical piece. That is, in S1508, the system (server 100D) sequentially receives portions of the musical score of the musical piece (second musical piece). The distribution site can stream the musical piece to the communication terminal 200D, and the communication terminal 200D can sequentially transfer, to the server 100D, portions of the musical score that is received.

Each time (a portion of) the music stream is acquired, the system (server 100D) carries out, in parallel, real-time generation of a second sound using the selected acoustic model 120 and display of the degree of proficiency of that acoustic model 120D (S1509, S1510). In parallel with the real-time generation, the system (server 100D) acquires (evaluates), in real time, the degree of proficiency of the acoustic model 120D with respect to a portion of the musical score, based on the portion of the musical score that is received and the characteristic distribution of the acoustic model 120D (S1509). Subsequently, the server 100D uses the acoustic model 120D to process the portion of the musical score, generates second acoustic features corresponding to that portion in real time, synthesizes and plays the sound waveform (second sound) in real time based on the second acoustic features, and displays the acquired degree of proficiency in real time (S1510).

This disclosure is not limited to the embodiments described above, and can be modified within the scope of the spirit of this disclosure.

### 6. Sixth Embodiment

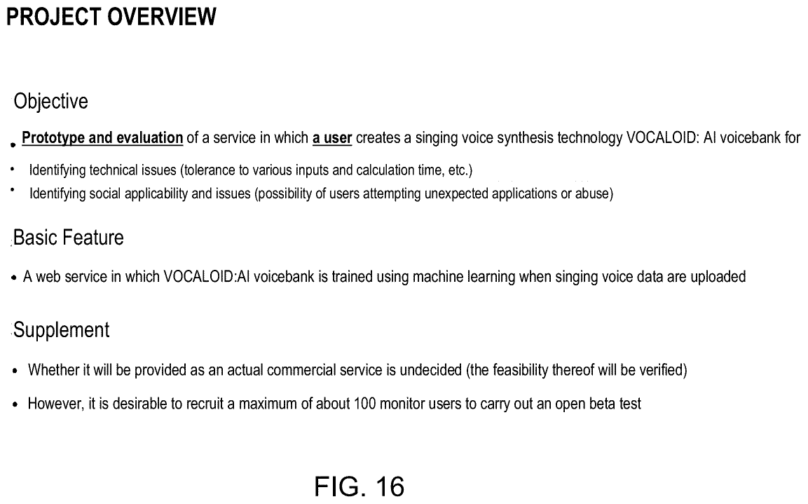

A service according to one embodiment of this disclosure will be described with reference to FIGS. 16 to 24.

FIG. 16 is a diagram explaining a project overview of a service according to one embodiment of this disclosure. FIG. 16 provides an explanation relating to a project overview. The following items are listed under “Project Overview.”
Objective
Basic Feature
Supplement

The following content is described under the item “Objective.”
Prototype and evaluation of a service in which a user creates a singing voice synthesis technology VOCALOID:AI voicebank.
Identifying technical issues (tolerance to various inputs and calculation time, etc.).
Identifying social applicability and issues (possibility of users attempting unexpected applications or abuse).

The following content is described under the item “Basic Feature.”
A web service in which VOCALOID:AI voicebank is trained using machine learning when singing voice data are uploaded.

The following content is described under the item “Supplement.”
Whether it will be provided as an actual commercial service is undecided (the feasibility thereof will be verified).
However, it is desirable to recruit a maximum of about 100 monitor users to carry out an open beta test.

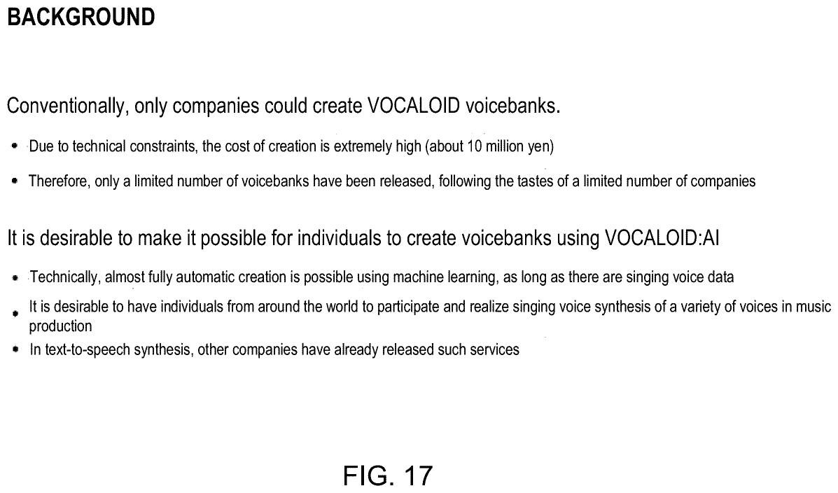

FIG. 17 is a diagram providing background information of the service according to one embodiment of this disclosure. FIG. 17 provides background information. The following items are listed under “Background.”
(A) Conventionally, only companies could create VOCALOID voicebanks.
(B) It is desirable to make it possible for individuals to create voicebanks using VOCALOID:AI.

The following content is described under (A).
Due to technical constraints, the cost of creation is extremely high (about 10 million yen).
Therefore, only a limited number of voicebanks have been released, following the tastes of a limited number of companies.

The following content is described under (B).
Technically, almost fully automatic creation is possible using machine learning, as long as there are singing voice data.
It is desirable to have individuals from around the world to participate and realize singing voice synthesis of a variety of voices in music production.
In text-to-speech synthesis, other companies have already released such services

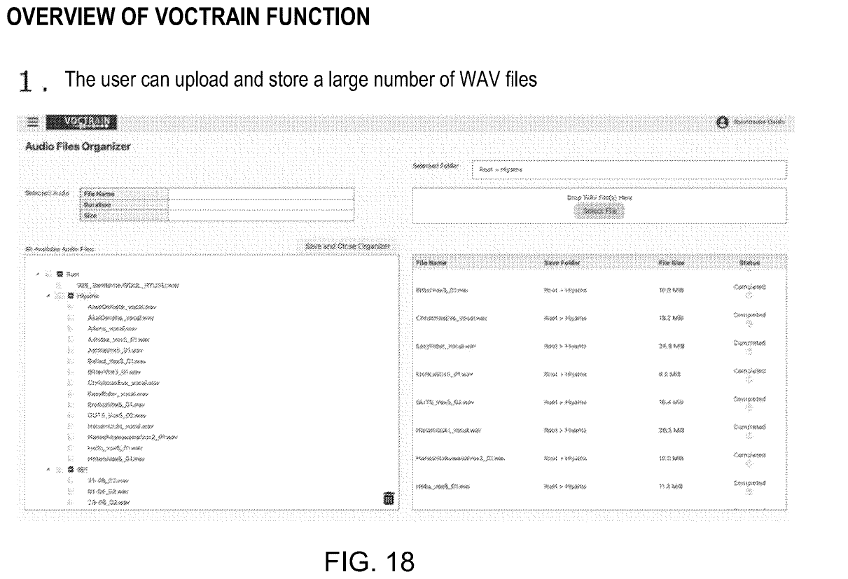

FIG. 18 is a diagram explaining an overview of functions of the service according to one embodiment of this disclosure. FIG. 18 describes an “Overview of voctrain function.” Voctrain is the name of a service according to one embodiment of this disclosure. FIG. 18 shows one example of a user interface provided in said service.

The following content is described under the “Overview of voctrain function” in FIG. 28.

### 1. The User can Upload and Store a Large Number of WAV Files.

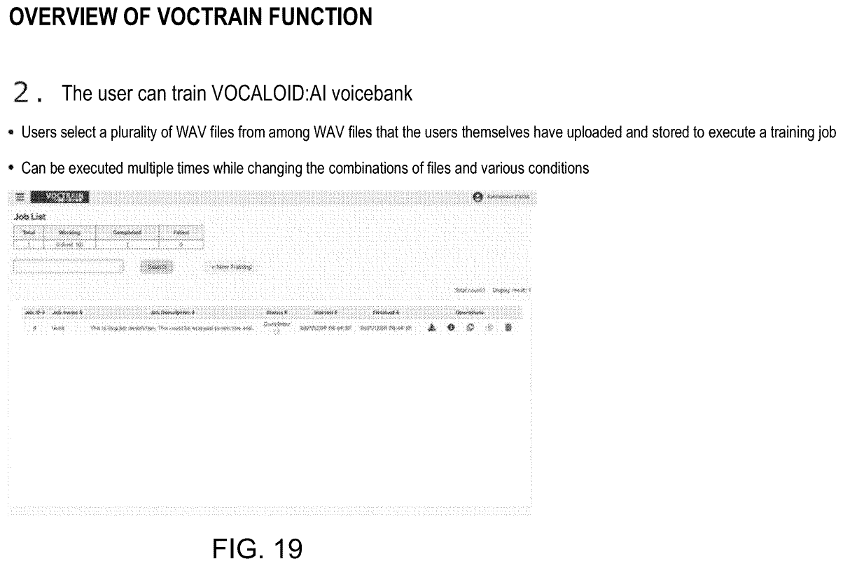

FIG. 19 is a diagram explaining an overview of functions of the service according to one embodiment of this disclosure. FIG. 19 describes an “Overview of voctrain function.” FIG. 29 shows one example of a user interface provided in said service.

The following content is described under the “Overview of voctrain function” in FIG. 29.

### 2. The User can Train VOCALOID:AI Voicebank.

Users select a plurality of WAV files from among WAV files that the users themselves have uploaded and stored to execute a training job.
Can be executed multiple times while changing the combinations of files and various conditions.

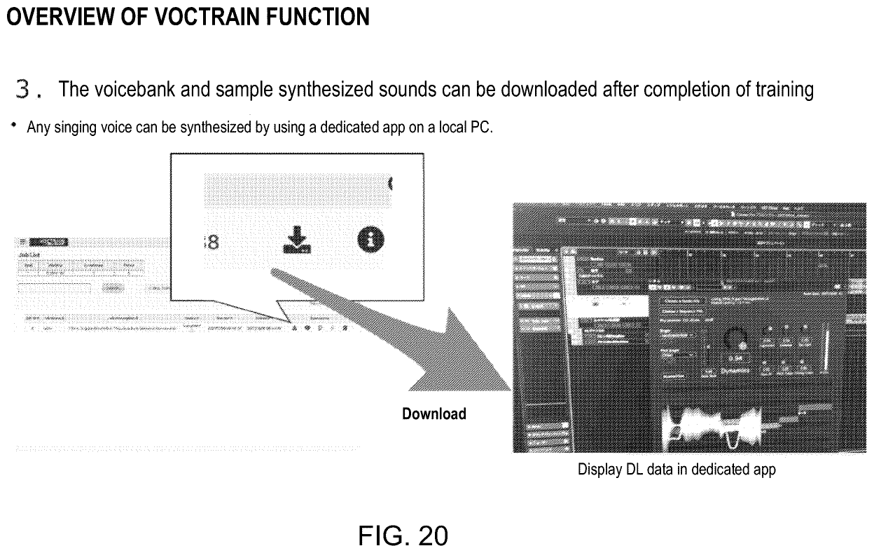

FIG. 20 is a diagram explaining an overview of functions of the service according to one embodiment of this disclosure. FIG. 30 describes an “Overview of voctrain function.” FIG. 20 shows a user interface provided in said service and an example of a sound waveform that has been downloaded to a dedicated application (dedicated app).

The following content is described under the “Overview of voctrain function” in FIG. 20.

3. The Voicebank and Sample Synthesized Sounds can be Downloaded after Completion of Training.
Any singing voice can be synthesized by using a dedicated app on a local PC.

As shown in FIG. 20, when a “Download” icon displayed on the user interface is selected, a sound waveform linked with the selected icon is downloaded. A screen displaying the downloaded data (DL data) in the dedicated app is shown in FIG. 30.

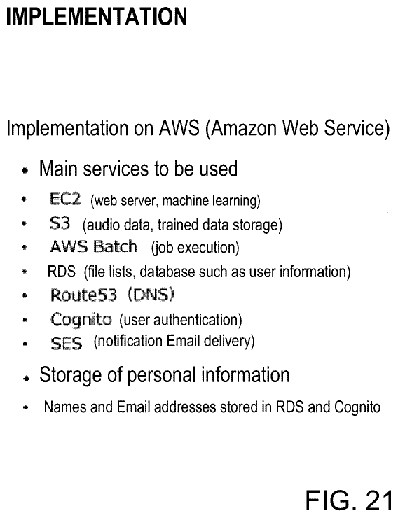

FIG. 21 is a diagram explaining implementation in the service according to one embodiment of this disclosure. FIG. 21 provides an explanation relation to implementation. The following items are listed under “Implementation.”
Implementation on AWS (Amazon Web Service).

The following items are listed under the item “Implementation on AWS.”
Main services to be used
Storage of personal information

The following items are listed under the item “Main services to be used.”
EC2 (web server, machine learning)
S3 (audio data, trained data storage)
AWS Batch (job execution)
RDS (file lists, database such as user information)
Route53 (DNS)
Cognito (user authentication)
SES (notification Email delivery)

The following content is described under the item “Storage of personal information.”
Names and Email addresses stored in RDS and Cognito

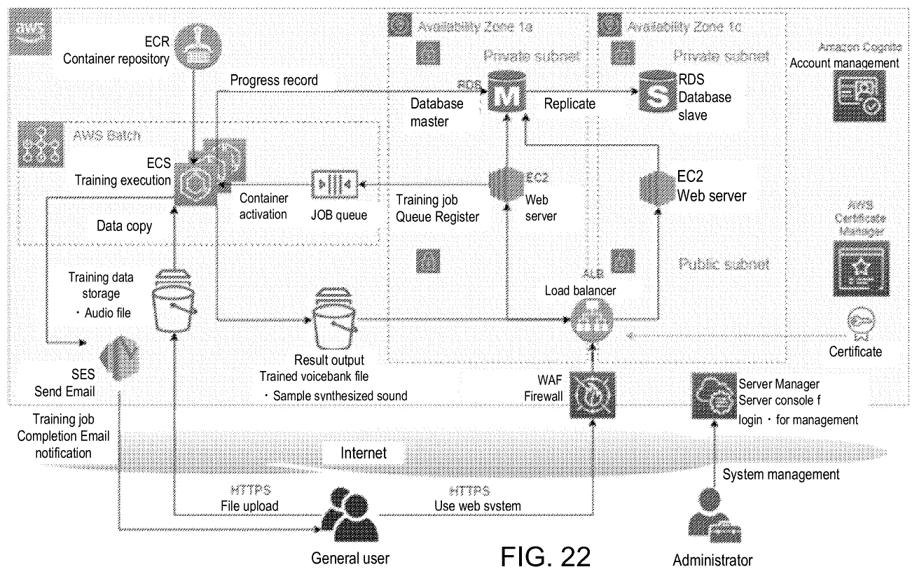

FIG. 22 is a diagram explaining a system configuration of the service according to one embodiment of this disclosure. In FIG. 22, audio files uploaded (HTTPS file upload) by general users are stored in the training data storage. Audio files stored in the training data storage are copied (data copy) to ECS (Elastic Container Service), and the acoustic model is trained in the ECS. When the training is executed, the result is output. The output result includes a trained voicebank file and sample synthesized sounds. The output result is transferred to a web server (EC2 web server) directly or via a load balancer (ALB load balancer).

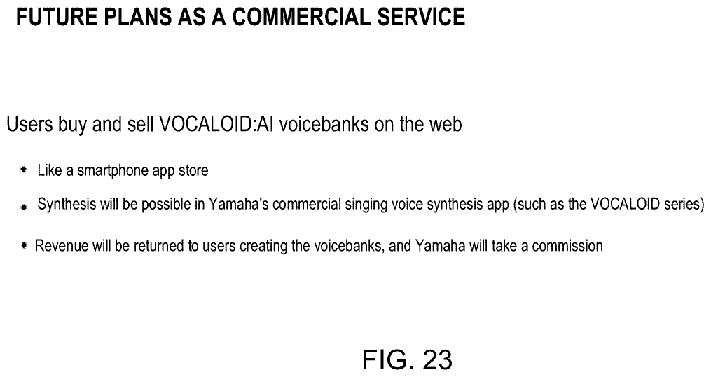

FIG. 23 is a diagram explaining future plans as a commercial service regarding the service according to one embodiment of this disclosure. FIG. 23 provides an explanation of future plans as a commercial service. The following items are listed under “Future plans as a commercial service.”

### (C) Users Buy and Sell VOCALOID:AI Voicebanks on the Web

The following content is described under (C).
Like a smartphone app store.
Synthesis will be possible in Yamaha's commercial singing voice synthesis app (such as the VOCALOID series).
Revenue will be returned to users creating the voicebanks, and Yamaha will take a commission

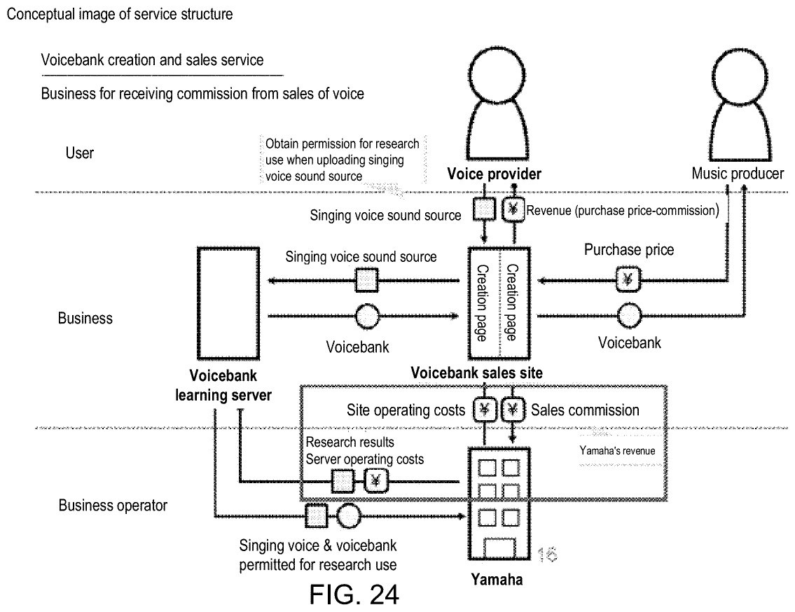

FIG. 24 is a diagram showing a conceptual image of a structure of the service according to one embodiment of this disclosure. As shown in FIG. 24, the voicebank creation and sales service is a business for receiving commission from the sales revenue of voice sales. The users are voice providers and music producers. The business will include a voicebank learning server and a voicebank sales site.

The voicebank sales site includes a creation page and a sales page. A voice provider provides (uploads) a singing voice sound source to the creation page. When uploading a singing voice sound source, the creation page asks the voice provider permission to use the singing voice sound source for the purpose of research. A voicebank is provided from the sales page to a music producer when the music producer pays the purchase price on the sales page.

The business operator bears the site operating costs of the voicebank sales site, and, in return, receives sales commission from the voicebank sales site as the business operator's proceeds. The voice provider receives, as proceeds, the amount obtained by subtracting the commission (sales commission) from the purchase price.

The singing voice sound source provided by the voice provider is provided from the creation page to a voicebank learning server. The voicebank learning server provides, to the business operator, voicebanks and singing voice sound sources for which research use has been permitted. The business operator bears the server operating costs of the voicebank learning server, and reflects the research results of the business operator on the voicebank learning server. The voicebank learning server provides, to the creation page, voicebanks obtained based on the singing voice sound sources that have been provided.

This disclosure is not limited to the embodiments described above, and can be modified within the scope of the spirit of this disclosure. For example, an embodiment according to the present embodiment can be configured as follows.

### Disclosure 1-1

### 1. Summary of the Disclosure

In a training control method for an acoustic model,
a plurality of waveforms are uploaded from a terminal to the cloud in advance; the desired waveform is selected with the terminal from among the uploaded waveforms; in response to an instruction to initiate a training job for an acoustic model, the selected waveform is used to execute the training of the acoustic model in the cloud; and the trained acoustic model is provided to the terminal, thereby
efficiently controlling the training of the acoustic model in the cloud (server) from the terminal (device).

It is a networked machine learning system.

### 2. Value of this Disclosure to the Customer

It becomes easy to control training jobs in the cloud from a terminal.

It is possible to easily initiate and try different acoustic model training jobs while changing the combination of waveforms to be used for the training.

### 3. Prior Art

Training acoustic models in the cloud
A terminal uploads a waveform for training to the cloud.
The cloud trains an acoustic model using the uploaded waveform and provides a trained acoustic model to the terminal.
The terminal must upload a waveform each time training is carried out.

### 4. Effect of the Disclosure

It becomes easy to control training jobs in the cloud from a terminal.

### 5. Configuration of the Disclosure (Main Points, Such as Structure, Method, Steps, and Composition)

### Definitions of Terms

One or more servers: Includes single servers and a cloud consisting of a plurality of servers.

First device, second device: Not specific devices; rather the first device is a device used by the first user, and the second device is a device used by the second user. When the first user is using their own smartphone, the smartphone is the first device, and when using a shared personal computer, the shared computer is the first device.

### [Basic System]

(1) A system for training an acoustic model that generates acoustic features comprising,
at least a first device of a first user, and one or more servers, each connected to a network, wherein
the first device, under control by the first user,
   uploads a plurality of waveforms to the one or more servers,
   selects one set of waveforms from the uploaded waveforms, and
   instructs the one or more servers to initiate a training job for the acoustic model, and
the one or more servers, in response to the initiation instruction from the first device,
   executes the training job for the acoustic model using the one set of waveforms, and
   provided an acoustic model trained by the training job to the first device.

### Disclosure to Other Users

(2) The machine learning system of (1),
further comprising a second device of a second user that is connected to the network, wherein
the first device, under control by the first user,
   instructs the one or more servers to disclose the initiated training job, and
   the one or more servers, in response to the disclosure instruction,
   provides information indicating a status of the executed training job to the second device.
(3) In the machine learning system of (2),
the status of the training job changes with the passage of time, and
the one or more servers
   repeatedly provides information indicating the current status of the executed training job to the second device.

### [Parallel Execution of Multiple Training Jobs]

(4) In the machine learning system of (1),
the first device, under control by the first user,
   can select a plurality of sets of waveforms and instruct the one or more servers to initiate a corresponding plurality of training jobs in parallel, and
the one or more servers, in response to the plurality of initiation instructions,
   executes the plurality of training jobs using the plurality of sets of waveforms in parallel.
(5) The machine learning system of (4),
further comprising a second device of a second user that is connected to the network, wherein
the first device, under control by the first user,
   selectively instructs the one or more servers to disclose a desired training job from among the plurality of the executed training jobs, and
the one or more servers, in response to the disclosure instruction,
   provides, to the second device, information relating to the training job for which disclosure was selectively instructed, from among the plurality of ongoing training jobs.

### [Online Billing]

(6) In the machine learning system of (1),
the one or more servers, in response to the initiation instruction from the first device,
   bills the first user compensation for the execution of the training job, and
   execution of the training job for the acoustic model and provision of the trained acoustic model to the first device are executed when the billing is successful.

### [Karaoke Room Billing]

(7) In the machine learning system of (1),
the first device is installed in a room rented by the first user, and compensation for the execution of the training job is included in the rental fee for the room.
(8) In the machine learning system of (7),
the room is a soundproof room provided with headphones for accompaniment play and a microphone for collecting sound.

### [Musical Piece Recommendation]

(9) In the machine learning system of (1),
the one or more servers
   analyzes a plurality of the uploaded waveforms,
   selects a musical piece suited to the first user based on the analysis result, and
   provides information indicating the selected musical piece to the first device.
(10) In the Machine Learning System of (9)
the analysis result indicates one or more from among performance sound range in which the first user is proficient, favorite music genre of the first user, and favorite performance style of the first user.
(11) In the machine learning system of (9),
the analysis result indicates a first user's playing skill.

### 6. Additional Explanation

As a previous step before executing a training job using a sound waveform selected by a user from a plurality of sound waveforms, such an interface is provided to the user.

The present disclosure assumes that waveforms are uploaded, but the essence is that training is performed using a waveform selected by a user from uploaded waveforms. Therefore, it suffices that the waveforms exist somewhere in advance, which is why the expression “preregistered” is used.

In an actual service, IDs are more likely assigned on a per-user basis, rather than a per-device basis.

Since it is expected that a user will log in to the service using a plurality of devices, an entity that issues instructions and the recipient of the trained acoustic model are defined as the “first user.”

In a disclosure to other users, the progress and the degree of completion of the training are disclosed. Depending on the information that is disclosed, it is possible to check the parameters in the process of being refined by the training, and to do trial listening to sounds using the parameters at that time point.

A voicebank creator can complete training based on the disclosed information. When the cost of a training job is usage-based, the creator can execute training in consideration of the balance between the cost and the degree of completion of the training, which allows for greater degree of freedom with respect to the level of training provided to the creator.

A general user can enjoy the process of the voicebank being completed while watching the progress of the training.

The current degree of completion is displayed numerically or as a progress bar.

The present disclosure can be implemented in a karaoke room. In that case, the cost of the training job can be added to the rental fee of the karaoke room.

The karaoke room can be defined as a “rented space.” While configurations other than rooms are not specifically envisioned, the foregoing is to avoid limiting the interpretation to only “rooms.”

User accounts can be associated with room IDs.

In addition to sound waveforms, accompaniment (pitch data) and lyrics (text data) can be added to a sound waveform as added information.

The recording period can be subdivided.

The recorded sound can be checked before uploading.

When billing, the amount can be determined in accordance with the amount of CP used (complete usage-based system) or be determined based on a basic fee+usage-based system (online billing).

Sound waveforms can be recorded and updated in a karaoke room (hereinafter referred to as karaoke room billing).

The user account for the service for updating a sound waveform and carrying out a training job can be associated with the room ID of the karaoke room to identify the user account with respect to an upload ID that identifies the uploaded sound waveform.

The user account can be associated with the room ID at the time of reservation of the karaoke room.

It is made possible to specify the period for recording when using karaoke. Whether to record can be specified on a per-musical-piece basis, and prescribed periods within musical pieces can be recorded.

Before uploading, whether it is necessary to upload can be determined after doing a trial listening to the recorded data.

The music genre is determined for each musical piece. Examples of music genres include rock, reggae, and R&B.

The performance style is determined by the way of singing. The performance style can change even for the same musical piece. Examples of performance styles include singing with a smile, or singing in a dark mood. For example, vibrato refers to a “performance style that frequently uses vibrato.” The pitch, volume, timbre, and dynamic behaviors thereof change overall with the style.

The playing skill refers to singing techniques, such as kobushi.

The music genre, performance style, and playing skill can be recognized from the singing voice using AI.

It is possible to ascertain, from the uploaded sound waveforms, ranges that are lacking and sound intensity. Thus, it is possible to recommend to the user musical pieces that contain the lacking ranges and sound intensity.

### Disclosure 1-2

### 1. Summary of the Disclosure

In a display method relating to an acoustic model trained to generate acoustic features corresponding to unknown input data using training data including first input data and first acoustic features, history data relating to the first input data used for the training are provided to the acoustic model, and a display corresponding to the history data is carried out before or during generation of sound using the acoustic model.

The user is able to ascertain the capability of the trained acoustic model.

The training history of the acoustic model is used.

### 2. Value of this Disclosure to the Customer

The user is able to know the strengths and weaknesses of the acoustic model based on the history data.

### 3. Prior Art

Training of acoustic models/JP6747489.
After basic training of the acoustic model, additional training can be carried out as necessary.
It is difficult for a user to determine whether a waveform to be used for basic training is sufficient.
It is difficult for a user to determine what type of waveform is best to use for additional training.

Sound generation using an acoustic model
When an acoustic model is used to process input data and generate sound, it is difficult for a user to determine whether the input data are within the trained domain or the untrained domain of the acoustic model.

### 4. Effect of the Disclosure

The user is able to know the strengths and weaknesses of the acoustic model based on the history data.

### 5. Configuration of the Disclosure (Main Points, Such as Structure, Method, Steps, and Composition)

(1) A method of displaying information relating to an acoustic model, realized by a computer, wherein
the acoustic model is trained to generate acoustic features corresponding to unknown second input data using training data including first input data and first acoustic features, and is provided with history data relating to the first input data used for the training, and
a display corresponding to the history data is carried out, in relation to sound generation using the acoustic model.

### [Displaying Learning Status of the Acoustic Model]

(2) In the display method of (1),
the display step displays the learning status of the acoustic model based on the history data, with respect to any feature indicated by the second input data.
   Displays what type of input data the acoustic model has learned.
(3) In the display method of (2),
the learning status for which a distribution is displayed relates to any one of the characteristics of pitch, intensity, phoneme, duration, and style, indicated by the second input data.
   For example, ranges of pitch and intensity that have been learned are displayed.
   For example, styles that have been learned are displayed.

### [Displaying Degree of Proficiency for Each Musical Piece]

(4) In the display method of (1),
the display step estimates and displays, in relation to sound generation based on second input data generated from a certain musical piece, degree of proficiency of the acoustic model relating to the musical piece based on the second input data and the history data.
   Displays whether the acoustic model is proficient in the musical piece for which sound generation is about to be carried out.
(5) In the display method of (4),
the step for estimating and displaying comprises
estimating the degree of proficiency of the acoustic model for each part of the musical piece (on the time axis), and
displaying the estimated degree of proficiency in association with each part of the musical piece.
   For example, each note of the musical piece is displayed while changing the color thereof in accordance with the degree of proficiency (proficient notes in blue, unproficient notes in red, etc.).
(6) In the display of (4),
the degree of proficiency for which a distribution is displayed relates to any one or more of the characteristics of pitch, intensity, phoneme, duration, or style, indicated by the second input data of the musical piece.

### [Displaying a Recommended Musical Piece Based on Degree of Proficiency]

(7) In the display method of (1),
the display step comprises
   estimating the degree of proficiency of each musical piece based on second input data of a plurality of musical pieces and the history data, and
   displaying, from among the plurality of musical pieces, a musical piece for which the estimated degree of proficiency is high as a recommended musical piece.

### [Displaying Degree of Proficiency in Real Time]

(8) In the display method of (1),
the display step comprises
   receiving, in real time, the second input data relating to sound generation using the acoustic model during the execution of the sound generation, and
   acquiring and displaying, in real time, the degree of proficiency of the acoustic model based on the received second input data and the history data.

### 6. Additional Explanation

For example, intensity and pitch can be set as the x and y axes, and the degree of learning at each point can be displayed using color or on an n axis.

With respect to the learning status, for example, when the second input data are data sung with a male voice, the suitability of the learning model for that case is displayed in the form of “xx %.”

The learning status indicates which range of sounds has been well learned, in a state in which the song that is desired to be sung has not yet been specified. On the other hand, the degree of proficiency is calculated after the song has been decided, in accordance with the range of sounds contained in the song and the learning status in said range of sounds. When a musical piece to be created is specified, it is determined how well the current voicebank is suited (degree of proficiency) for that musical piece. For example, it is determined whether the learning status of the intensity and range of sounds used in the musical sound is sufficient.

The determination of the degree of proficiency can be made, not only for each musical piece, but also for a certain section within a certain musical piece.

If the performance style has been learned, it is also possible to select MIDI data to recommend in accordance with the style.

A musical piece used for learning and musical pieces similar thereto are selected as recommended musical pieces. In this case, if the style has been learned, it is possible to recommend musical pieces that match the style.

### Disclosure 1-3

### 1. Summary of the Disclosure

In a method for training an acoustic model using a plurality of waveforms,
by acquiring a characteristic distribution of a waveform that is or was used for training and displaying the characteristic distribution that has been acquired,
the user can ascertain the training status of the acoustic model.

The trend of the waveform set used for training is displayed.

### 2. Value of this Disclosure to the Customer

By identifying and preparing waveforms that are lacking in training, the user can efficiently train the acoustic model.

### 3. Prior Art

Training of acoustic models/JP6747489.
After basic training of the acoustic model, additional training can be carried out as necessary.
It is difficult for a user to determine whether a waveform to be used for basic training is sufficient.
It is difficult for a user to determine what type of waveform is best to use for additional training.

### 4. Effect of the Disclosure

The user can determine, by looking at the display, whether the waveform used for basic training is sufficient.

The user can determine, by looking at the display, what type of waveform is lacking.

### 5. Configuration of the Disclosure (Main Points, Such as Structure, Method, Steps, and Composition)

### [Display of Training Data Distribution]

(1) A method for training an acoustic model using a plurality of waveforms, realized by a computer, the method comprising
acquiring a characteristic distribution of any one of waveforms used or to be used for the training, and
displaying the characteristic distribution that has been acquired or information relating to the characteristic distribution.

### Effects of the Disclosure

The user can ascertain the training status of the acoustic model.
Example: a histogram in the pitch direction or the intensity direction is displayed.
(2) In the training method of (1),
the characteristic distribution that is acquired is the distribution of one or more of the characteristics of pitch, intensity, phoneme, duration, and style.
(3) In the training method of (1),
the characteristic distribution that is acquired and displayed is a two-dimensional distribution of first and second characteristics of the plurality of waveforms.
   Example, a two-dimensional histogram of pitch and intensity is displayed.
(4) In the training method of (1),
in the acquisition step,
   first and second characteristics of the plurality of waveforms are detected, and
   of the plurality of waveforms, a distribution of the second characteristic of a waveform in which the first characteristic is a prescribed value is acquired, and
in the display step,
   the distribution of the second characteristic that is acquired is displayed.
   Example: a histogram in the pitch direction of a waveform with strong or weak intensity is displayed.
   Example: a histogram in the pitch direction of a staccato waveform with a short note duration is displayed.

### [Indication of Lacking Data]

(5) The training control method of (1), further comprising
detecting gaps in the acquired characteristic distribution, wherein
in the display step,
information relating to the detected gaps is displayed.
(6) In the training control method of (5),
the information relating to the gap indicates a characteristic value of the gap.
   The user can recognize the characteristic value of the gap and prepare a waveform to fill the gap.
(7) The training control method of (5), further comprising
a step for identifying a musical piece suitable for filling the gap, wherein
the information relating to the gap indicates the identified musical piece.
   The user can play and record the displayed musical piece to fill the gap.

### 6. Additional Explanation

As a specific example of a learning status (characteristic distribution), for example, with sound intensity as the horizontal axis and sound range as the vertical axis, the degree of learning of the training can be displayed in color on a two-dimensional graph.

When a waveform that is planned to be used for training is selected (for example, checking a check box), the characteristic distribution of said waveform can be reviewed. With this configuration, it is possible to visually check the characteristics that are lacking in the training.

The “characteristic value of the gap” of (6) indicates which sounds are lacking in the characteristic distribution.

The “identify a musical piece” of (7) means to recommend a musical piece suitable for filling in the lacking sounds.

### Disclosure 1-4

### 1. Summary of the Disclosure

In a training method for an acoustic model that generates acoustic features based on symbols (text or musical score),
a plurality of received waveforms are analyzed, sections containing sounds of the target timbre are detected, and the waveforms of the detected sections are used to train the acoustic model,
thereby establishing a higher-quality acoustic model.

Automatic selection of waveforms used for training.

### 2. Value of this Disclosure to the Customer

A higher-quality acoustic model can be established based on waveforms selected by the user.

### 3. Prior Art

Training of acoustic models/JP6747489.
After basic training of the acoustic model, additional training can be carried out as necessary.
The quality of the acoustic model is greatly affected by the quality of the waveform used for training.
It is tedious for a user to select waveforms to be used for training.

Selection of training data/JP4829871
Automatically select training data suitable for training a voice recognition model.
This disclosure is for automatically selecting voice data for improving recognition scores of a voice recognition model, which cannot be easily applied to selecting sound data suitable for training of sound synthesis and singing voice synthesis.

### 4. Effect of the Disclosure

A higher-quality acoustic model can be established based on waveforms selected by the user.

### 5. Configuration of the Disclosure (Main Points, Such as Structure, Method, Steps, and Composition)

(1) A training method for an acoustic model that generates acoustic features based on a sequence of symbols (text or musical score), the method comprising
receiving an input waveform,
analyzing the input waveform,
detecting a plurality of sections containing sounds of a specific timbre based on the analysis results, and
using waveforms of the plurality of sections to train the acoustic model.

### [User Makes the Final Determination]

(2) The training method of (1), further comprising
displaying the detected plurality of sections along a time axis of the input waveform, and
adjusting at least one section from among the plurality of sections in accordance with a user's operation.

Here, the training step of the acoustic model is executed using the waveforms of the plurality of sections including adjusted sections.
(3) The training method of (2), wherein
the adjustment is any of changing, deleting, and adding a boundary of the one section.
(4) The training method of (2), wherein
the waveform of the section to be adjusted is played back.

### [Removing Silence and Determining Specific Timbres]

(5) The training method of (1), wherein
in the analysis step,
   presence/absence of sound is determined along a time axis of the input waveform, and
   the timbre of the waveform in the section that is determined to contain sound is determined, and
in the detection step,
   the plurality of sections in which the determined timbres are the specific timbres are detected.
      [Removing Accompaniment Sounds and Noise Other than the Specific Timbres]
(6) The training method of (1), wherein
in the analysis step,
   waveforms of the specific timbres are separated at least from waveforms in the sections determined to contain sound, and
   the separated waveforms of the plurality of sections are used for the training of the acoustic model.
(7) The training method of (6), wherein
in the separation step,
   at least one of accompaniment sounds, reverberation sounds, and noise is removed.

### [Copyright Protection of Existing Content]

(8) The training method of (1), wherein
in the analysis step,
   whether the input waveform has at least a partial existing content mixed therein is determined, and
in the detection step,
   a plurality of sections containing sounds of the specific timbres are detected from sections of the input waveform that do not contain the existing content.

### 6. Additional Explanation

The present disclosure is a training method for an acoustic model that generates acoustic features for synthesizing sound waveforms when input data are provided.

The present disclosure differs from the voice recognition of JP4829871 in the point of generating acoustic features based on a sequence of symbols.

It is possible to efficiently train an acoustic model using only sections containing desired timbres (it becomes possible to train while excluding unnecessary regions, noise, etc.).

By adjusting the selected sections of a waveform, it is possible to use sections corresponding to the user's wishes to execute training of the acoustic model.

The presence/absence of sound can be determined based on a certain threshold value of the volume. For example, a “sound-containing section” can be portions where the volume level is above a certain level.

### Disclosure 1-5

### 1. Summary of the Disclosure

A method of selling acoustic models, wherein
a user is supplied with a plurality of acoustic models, each with added information; the user selects any one acoustic model from the plurality of acoustic models; the user prepares a reference audio signal; under the condition that the added information of the acoustic model selected by the user indicates permission to retrain, the reference audio signal prepared by the user is used to train the acoustic model; and the trained acoustic model obtained as a result of said training is provided to the user; thereby
enabling a creator to selectively supply a part of a plurality of acoustic models as a base model, and enabling the user to use the base model to easily create an acoustic model.

### 2. Value of this Disclosure to the Customer

A creator can selectively supply a part of a created acoustic model as a base model, and
a user can use the provided base model to easily create a new acoustic model.

### 3. Prior Art

Training of acoustic models/JP6747489
After basic training of the acoustic model, additional training can be carried out as necessary.
The quality of the acoustic model is greatly affected by the quality of the waveform used for training.
It is tedious for a user to select waveforms to be used for training.

Selling user models/JP6982672
A first model published by a first party is used for retraining by a second party to generate and publish a second model.
When the second model is sold, the revenue is split between the first and second parties.
Once a model is published, the model can be freely used for retraining by a third party.

According to this disclosure, publishing is possible so as not to be used for retraining.

### 4. Effect of the Disclosure

A creator can selectively supply a part of a created acoustic model as a base model, and
a user can use the provided base model to easily create a new acoustic model.

### 5. Configuration of the Disclosure (Main Points, Such as Structure, Method, Steps, and Composition)

(1) A method of providing an acoustic model (to a user), the method comprising
(the user) obtaining a plurality of acoustic models each with corresponding added information,
(the user) preparing a reference audio signal,
(the user) selecting any one acoustic model from the plurality of acoustic models,
(in accordance with an instruction from the user) retraining the one acoustic model using at least the reference audio signal, under the condition that the added information of the one selected acoustic model can be used as a base model for retraining, and
providing (to the user) the retrained acoustic model obtained as a result of the retraining.

### Effects of the Disclosure

A creator can selectively supply a part of a plurality of acoustic models as a base model, and the user can use the base model to easily create an acoustic model.
(2) In the provision method of (1),
the added information includes a permission flag indicating whether the model can or cannot be used as a base model for retraining.

### Effects of the Disclosure

When retraining in the cloud, restricting use is simple and easy using a permission flag.
(3) In the provision method of (1),
a different training process is defined for each of the plurality of acoustic models,
the added information is procedure data indicating a training process for the one acoustic model, and
in the retraining step,
the one acoustic model is retrained by carrying out a training process indicated by the procedure data.

### Effects of the Disclosure

It is possible to more strongly protect acoustic models for which additional training is not desired. This is because additional training cannot be carried out if the training process is unknown.
(4) In the provision method of (1),
each piece of added information indicates features of the corresponding acoustic model, and
in the selection step,
   characteristics of the reference audio signal are analyzed, and
   the any one acoustic model is selected from among the plurality of acoustic models based on the analyzed characteristics and the features indicated by the added information of each acoustic model.

### Effects of the Disclosure

Additional learning can be efficiently carried out by selecting an acoustic model that matches the characteristics of the reference audio signal.
(5) In the provision method of (1),
one test musical piece is processed with each of the plurality of acoustic models to generate a plurality of audio signals of the musical piece, and
in the selection step,
   the one acoustic model is selected based on the plurality of generated audio signals.

### Effects of the Disclosure

Any one acoustic model can be selected in accordance with the audio signal generated by each acoustic model.
(6) In the provision method of (5),
in the selection step,
   characteristics of the reference audio signal and characteristics of each of the plurality of audio signals are analyzed, and
   the any one acoustic model is selected from among the plurality of acoustic models based on the characteristics of the reference audio signal and the characteristics of each of the audio signals.

### Effects of the Disclosure

Even if the added information does not indicate the features of each acoustic model, additional learning can be more efficiently carried out by selecting an acoustic model that matches the characteristics of the reference audio signal.
(7) In the provision method of (1),
the plurality of acoustic models are created by one or more creators,
each creator attaches, to the acoustic model trained and created by the creator, added information indicating whether the model can or cannot be used as the base model, and sells the acoustic model (to the user), and
in the acquisition step,
the plurality of acoustic models are acquired by (the user) purchasing the plurality of acoustic models that are on sale.

### Effects of the Disclosure

When selling (to the user) an acoustic model created by a creator, the creator can specify whether the model can or cannot be used as a base model.
(8) The provision method of (7), further comprising
(the user) adding, to the retrained acoustic model that has been provided, added information indicating that the model can be used, or added information indicating that the model cannot be used, as the base model, and selling the model (to another user as the creator).

### Effects of the Disclosure

A user can sell (to another user) an acoustic model retrained by the user, while specifying (as the creator) whether the model can or cannot be used as a base model.
(9) The provision method of (7), further comprising
(the user) selling (to another user as the creator) the retrained acoustic model that has been provided.

The degree of change of the retrained acoustic model from the one acoustic model in the retraining is calculated, and
when the retrained acoustic model on sale is sold, the compensation therefor is shared (between the user and the creator of the base model) based on the calculated degree of change.

### Effects of the Disclosure

The user can receive compensation corresponding to the level of retraining that the user carried out.
(10) In the provision method of (7),
the added information indicating that the model can be used, which is added to the acoustic model by the creator, indicates the creator's share and further,
(the user) sells (to another user as the creator) the retrained acoustic model that has been provided.

When the retrained acoustic model on sale is sold, the compensation therefor is shared (between the user and the creator of the base model) based on the share indicated by the added information added to the one acoustic model.

### Effects of the Disclosure

When a user's retrained acoustic model is sold, the creator of the base model can receive a portion of the revenue.
(11) In the provision method of (1),
the plurality of acoustic models include untrained acoustic models provided with added information indicating whether the model can be used as a base model.

### Effects of the Disclosure

The user can train an untrained acoustic model from scratch.
(12) In the provision method of (1),
the plurality of acoustic models include, for each timbre type, a universal acoustic model that has been subjected to basic training for said timbre type, the model being provided with added information indicating whether the model can be used as a base model.

### Effects of the Disclosure

The user can perform retraining, starting with a universal acoustic model corresponding to a desired timbre type.

### 6. Additional Explanation

It can be assumed that training will be performed using different acoustic models. Different acoustic models can have configurations such as different neural networks (NNs), different connections between NNs, different sizes or depths of NNs, etc. Not knowing the training process between different acoustic models means that the retraining cannot be performed.

The “procedure data” can be data indicating the process itself, or an identifier that can identify the process.

When selecting one suitable acoustic model, acoustic features can be used, the acoustic features having been generated by inputting, into the acoustic model, music data (MIDI) that are the source of the “reference audio signal,” which is a sound waveform for training.

The creator of the original acoustic model can add, to the acoustic model created by the creator, added information determining whether the model can be used as a base model.

The acoustic model can be made available for sale and purchase.

When making a creator to add first added information, an interface for adding the first added information can be provided to the creator.

A user who trains an acoustic model can add, to a trained acoustic model, added information determining whether the model can be used as a base model for training. Compensation can be calculated based on the degree of change of the acoustic model due to training.

The creator of the original acoustic model can predetermine the creator's share.

If an identifier indicating that a model has been initialized is to be added to an “initialized acoustic model,” an indicator can be defined.

[Constituent Features that Specify the Disclosure]

The following constituent features may be set forth in the claims.

### [Constituent Feature 1]

A training method for providing, to a first user, an interface for selecting, from among a plurality of preregistered sound waveforms, one or more sound waveforms for executing a first training job for an acoustic model that generates acoustic features.

### [Constituent Feature 2]

A training method, comprising: executing a first training job on an acoustic model that generates acoustic features using one or more sound waveforms selected based on an instruction from a first user from a plurality of preregistered sound waveforms, and
providing, to the first user, the acoustic model trained by the first training job.

### [Constituent Feature 3]

The training method according to Constituent feature 2, further comprising disclosing information indicating a status of the first training job to a second user different from the first user based on a disclosure instruction from the first user.

### [Constituent Feature 4]

The training method according to Constituent feature 2, further comprising: displaying information indicating a status of the first training job on a first terminal, thereby disclosing the information to the first user; and displaying the information indicating the status of the first training job on a second terminal different from the first terminal, thereby disclosing the information to the second user.

### [Constituent Feature 5]

The training method according to Constituent feature 3 or 4, wherein the status of the first training job changes with the passage of time, and
the information indicating the status of the first training job is repeatedly provided to the second user.

### [Constituent Feature 6]

The training method according to Constituent feature 3 or 4, wherein the information indicating the status of the first training job includes a degree of completion of the training job.

### [Constituent Feature 7]

The training method according to Constituent feature 3, further comprising providing the acoustic model corresponding to a timing of the disclosure instruction to the first user based on the disclosure instruction.

### [Constituent Feature 8]

The training method according to Constituent feature 2, further comprising, based on an instruction from the first user,
selecting another set of sound waveforms from a plurality of uploaded sound waveforms,
initiating a second training job using the other set of sound waveforms with respect to the acoustic model, and
   executing the first training job and the second training job in parallel.

### [Constituent Feature 9]

The training method according to Constituent feature 8, wherein information indicating the status of the first training job and information indicating the status of the second training job are selectively disclosed to a second user different from the first user, based on a disclosure instruction from the first user.

### [Constituent Feature 10]

The training method according to Constituent feature 2, further comprising billing the first user in accordance with an instruction from the first user, and executing the first training job when the billing is successful.

### [Constituent Feature 11]

The training method according to Constituent feature 2, further comprising receiving a space ID identifying a space rented by the first user, and
associating an account of the first user for a service that provides the training method with the space ID.

### [Constituent Feature 12]

The training method according to Constituent feature 11, further comprising receiving pitch data indicating sounds constituting a song and text data indicating lyrics of the song, provided in the space, and sound data of a recording of singing during at least a portion of the period during which the song is provided, and
storing the sound data, as the uploaded sound waveforms, in association with the pitch data and the text data.

### [Constituent Feature 13]

The training method according to Constituent feature 12, further comprising recording only sound data of a specified period of the provision period, based on a recording instruction from the first user.

### [Constituent Feature 14]

The training method according to Constituent feature 12, further comprising playing back the sound data that have been received in the space based on a playback instruction from the first user, and
inquiring the first user as to whether to register the sound data played back in accordance with the playback instruction as one of the plurality of sound waveforms that can be selected based on an instruction from the first user.

### [Constituent Feature 15]

The training method according to Constituent feature 2, further comprising analyzing the uploaded sound waveform,
identifying a musical piece corresponding to the first user based on a result obtained by the analysis, and
providing information indicating the specified musical piece to the first user.

### [Constituent Feature 16]

The training method according to Constituent feature 15, wherein the analysis result indicates at least one of performance sound range, music genre, and performance style. [Constituent Feature 17]

The training method according to Constituent feature 15, wherein the analysis result indicates playing skill.

### [Constituent Feature 18]

A method for displaying information relating to an acoustic model that generates acoustic features, the method comprising
acquiring a characteristic distribution corresponding to a plurality of sound waveforms associated with training of the acoustic model, and
displaying information relating to the characteristic distribution.

### [Constituent Feature 19]

The display method according to Constituent feature 18, wherein the sound waveforms associated with the training of the acoustic model include sound waveforms that are or were used for the training.

### [Constituent Feature 20]

The display method according to Constituent feature 18, wherein the characteristic distribution that is acquired include the distribution of one or more of the characteristics of pitch, intensity, phoneme, duration, and style.

### [Constituent Feature 21]

The display method according to Constituent feature 18, wherein the characteristic distribution that is displayed is a two-dimensional distribution of a first characteristic and a second characteristic from among characteristics included in the characteristic distribution. [Constituent Feature 22]

The display method according to Constituent feature 18, wherein the acquisition of the characteristic distribution includes
extracting a first characteristic and a second characteristic from among characteristics included in the characteristic distribution, and
acquiring distribution of the second characteristic when the first characteristic is included in a prescribed range,
   and
the display of the characteristic distribution includes displaying the distribution of the second characteristic that has been acquired.

### [Constituent Feature 23]

The display method according to Constituent feature 18, further comprising detecting a region of the acquired characteristic distribution that satisfies a prescribed condition, and
displaying the region.

### [Constituent Feature 24]

The display method according to Constituent feature 23, wherein the display of the region includes displaying a feature value related to the region.

### [Constituent Feature 25]

The display method according to Constituent feature 23, wherein the display of the region includes displaying a musical piece corresponding to the region.

### [Constituent Feature 26]

The display method according to Constituent feature 18, wherein the acoustic model is a model that is trained using training data containing first input data and first acoustic features, and that generates second acoustic features when second input data are provided,
a sound waveform of history data related to the first input data is acquired as a sound waveform associated with training of the acoustic model, and the characteristic distribution corresponding to the history data is acquired, and
information relating to the characteristic distribution corresponding to the history data is displayed.

### [Constituent Feature 27]

The display method according to Constituent feature 26, further comprising displaying a learning status of the acoustic model for a given characteristic indicated by the second input data, based on the history data.

### [Constituent Feature 28]

The display method according to Constituent feature 27, wherein the given characteristic includes at least one characteristic of pitch, intensity, phoneme, duration, and style.

### [Constituent Feature 29]

The display method according to Constituent feature 26, further comprising evaluating a musical piece based on the history data and the second input data required for generating the musical piece, and displaying the evaluation result.

### [Constituent Feature 30]

The display method according to Constituent feature 29, further comprising dividing the musical piece into a plurality of sections on a time axis, and
evaluating the musical piece for each of the sections and displaying the evaluation result.

### [Constituent Feature 31]

The display method according to Constituent feature 29, wherein the evaluation result includes at least one characteristic of pitch, intensity, phoneme, duration, and style, indicated by the second input data required for generating the musical piece.

### [Constituent Feature 32]

The display method according to Constituent feature 26, further comprising evaluating each of a plurality of musical pieces based on the history data and the second input data required for generating the plurality of musical pieces, and
displaying at least one musical piece from among the plurality of musical pieces based on the evaluation result.

### [Constituent Feature 33]

The display method according to Constituent feature 26, further comprising receiving the second input data for a generated sound when generating the sound using the acoustic model,
evaluating the second acoustic features that have been generated based on the history data and the second input data that have been received, and
displaying the evaluation result together with the second input data. [Constituent Feature 34]

A training method for an acoustic model that generates acoustic features based on a sequence of symbols, the method comprising
detecting a specific section that satisfies a prescribed condition from among sound waveforms used for training, and
training the acoustic model based on the sound waveform included in the specific section.

### [Constituent Feature 35]

A training method for an acoustic model that generates acoustic features for synthesizing sound waveforms when input data are provided, the method comprising
detecting a specific section that satisfies a prescribed condition from among sound waveforms used for training, and
training the acoustic model based on the sound waveform included in the specific section.

### [Constituent Feature 36]

The training method according to Constituent feature 34 or 35, further comprising detecting a plurality of the specific sections along a time axis of the sound waveform, displaying the plurality of the specific sections, and
adjusting, in the direction of the time axis, at least one section from among the plurality of the specific sections that are displayed, based on an instruction from a user. [Constituent Feature 37]

The training method according to Constituent feature 34 or 35, further comprising detecting a plurality of the specific sections along a time axis of the sound waveform, and providing, to a user, an interface for displaying the plurality of the specific sections and for adjusting, in the direction of the time axis, at least one section from among the plurality of the specific sections that are displayed.

### [Constituent Feature 38]

The training method according to Constituent feature 36, wherein the adjustment is changing, deleting, or adding a boundary of the at least one section.

### [Constituent Feature 39]

The training method according to Constituent feature 36, further comprising playing back a sound based on the sound waveform included in the at least one section, the section being a target of the adjustment.

### [Constituent Feature 40]

The training method according to Constituent feature 34 or 35, wherein detecting the specific section includes
detecting a sound-containing section in the sound waveform along a time axis of the sound waveform,
detecting a first timbre of the sound waveform in the detected sound-containing section, and
   detecting the specific section in which the first timbre is included in the specific timbre. [Constituent Feature 41]

The training method according to Constituent feature 34 or 35, further comprising separating a waveform of the specific timbre from a waveform of the specific section of the sound waveform in which a sound-containing section is detected along a time axis of the sound waveform after the specific section is detected, and training the acoustic model based on the waveform of the separated specific timbre instead of the sound waveform included in the specific section.

### [Constituent Feature 42]

The training method according to Constituent feature 41, wherein the separation removes at least one of: a sound (accompaniment sound) played back together with the sound waveform at each time point on the time axis of the sound waveform; a sound (reverberation sound) mechanically generated based on the sound waveform; and a sound (noise) contained in a peak in the sound waveform in which the amount of change between adjacent time points is greater than or equal to a prescribed amount.

### [Constituent Feature 43]

The training method according to Constituent feature 34 or 35, wherein detecting the specific section includes
determining whether a prescribed content is included in at least a portion of the sound waveform that is received, and
excluding sections that do not include the prescribed content from the specific section. [Constituent Feature 44]

A method for providing an acoustic model that generates acoustic features, the method comprising
acquiring an acoustic model associated with first added information as a target of retraining using a sound waveform,
determining whether retraining on the acoustic model can be carried out based on the first added information, and
providing a retrained acoustic model obtained by executing retraining on the acoustic model when it is determined that retraining can be carried out.

### [Constituent Feature 45]

The method for providing an acoustic model according to Constituent feature 44, wherein the first added information is a flag indicating whether retraining on the acoustic model can be carried out.

### [Constituent Feature 46]

The method for providing an acoustic model according to Constituent feature 44, wherein the first added information includes procedure data indicating a process for retraining the acoustic model, and the retraining of the acoustic model is carried out based on the procedure data.

### [Constituent Feature 47]

The method for providing an acoustic model according to Constituent feature 44, wherein the first added information includes information indicating a first feature of the acoustic model, and
when the sound waveform used for retraining is identified, the acoustic model to be acquired as a target of retraining is selected from a plurality of acoustic models, each associated with the first added information, based on the first feature and a second feature of the sound waveform.

### [Constituent Feature 48]

The method for providing an acoustic model according to Constituent feature 44, wherein the acoustic model acquired as a target for retraining is selected from a plurality of acoustic models, each associated with the first added information,
music data related to the sound waveform are used to generate a plurality of audio signals based on the plurality of acoustic features using the plurality of acoustic models, and
the acoustic model to be acquired as a target for retraining is selected based on the sound waveform and the plurality of audio signals.

### [Constituent Feature 49]

The method for providing an acoustic model according to Constituent feature 44, further comprising selecting the acoustic model based on the plurality of the acoustic features and the sound waveform.

### [Constituent Feature 50]

The method for providing an acoustic model according to Constituent feature 44, wherein the acoustic model is an acoustic model created by one or more creators, and the first added information is information added by the one or more creators indicating whether retraining an acoustic model created by the creators can be carried out. [Constituent Feature 51]

The method for providing an acoustic model according to Constituent feature 44 or 50, wherein second added information is associated with the retrained acoustic model, and
the second added information is information, set by a user that executed retraining, indicating whether retraining the retrained acoustic model for which the user executed retraining can be carried out.

### [Constituent Feature 52]

The method for providing an acoustic model according to Constituent feature 44 or 50, further comprising, based on a payment procedure carried out by a purchaser who purchased the retrained acoustic model,
calculating a degree of change from the acoustic model as a target of retraining to the retrained acoustic model, and
calculating compensation for the acoustic model and compensation for the retrained acoustic model based on the degree of change.

### [Constituent Feature 53]

The method for providing an acoustic model according to Constituent feature 44 or 50, wherein the first added information includes share information, and
the share information is information indicating a ratio between compensation for the acoustic model as a target of retraining and compensation for the retrained acoustic model, in the compensation for the payment procedure by which a purchaser purchases the retrained acoustic model.

### [Constituent Feature 54]

The method for providing an acoustic model according to Constituent feature 44, wherein there are a plurality of the acoustic models,
the plurality of the acoustic models include an initialized acoustic model,
   the initialized acoustic model is provided with the first added information allowing the retraining, and
the initialized acoustic model is a model in which variables are replaced by random numbers.

### [Constituent Feature 55]

The method for providing an acoustic model according to Constituent feature 44, wherein there are a plurality of the acoustic models, and
the plurality of the acoustic models are associated with identifiers relating to the timbre type indicated by the acoustic features generated by the acoustic model.

### Effects of this Disclosure

According to one embodiment of this disclosure, it is possible to facilitate identification of a sound waveform to use for training of an acoustic model.

What is claimed is:

1. A method for displaying information relating to an acoustic model that is established by being trained using a plurality of sound waveforms so as to generate acoustic features, the method comprising:
acquiring characteristic distribution of the plurality of sound waveforms used for training of the acoustic model, a characteristic of the characteristic distribution being one or more sound waveform characteristics; and
displaying information relating to the characteristic distribution.

2. The display method according to claim 1, wherein
the characteristic distribution is acquired by analyzing the plurality of sound waveforms.

3. The display method according to claim 1, wherein
the information relating to the characteristic distribution indicates a lack of the training of the acoustic model.

4. The display method according to claim 1, wherein
the information relating to the characteristic distribution indicates an ability acquired by the acoustic model through the training.

5. The display method according to claim 1, wherein
the acquiring is performed by acquiring, before the training of the acoustic model that is expected to be established through the training, the characteristic distribution of the plurality of sound waveforms used for the training of the acoustic model, and
in the displaying, information relating to the characteristic distribution of the plurality of sound waveforms used for the training of the acoustic model is displayed.

6. The display method according to claim 5, wherein
the training is additional training, and
the characteristic distribution is a characteristic distribution obtained by analyzing a plurality of sound waveforms that have been used for previous training of the acoustic model before the additional training and a sound waveform that is additionally used for the additional training.

7. The display method according to claim 6, wherein
the acoustic model before the additional training is selected by a user from among a plurality of trained acoustic models.

8. The display method according to claim 1, wherein
the one or more sound waveform characteristics include one or more of pitch, intensity, phoneme, duration, or style.

9. The display method according to claim 1, wherein
the one or more sound waveform characteristics include a first characteristic and a second characteristic, and
in the displaying, a graph indicating a two-dimensional distribution of the first characteristic and the second characteristic is displayed.

10. The display method according to claim 1, wherein
the acquiring of the characteristic distribution is performed by analyzing the plurality of sound waveforms and acquiring, as the one or more sound waveform characteristics, a first characteristic and a second characteristic, and
in the displaying, the characteristic distribution of the second characteristic in a state in which the first characteristic is within a prescribed range is displayed.

11. The display method according to claim 1, wherein
the displaying includes
detecting, in the characteristic distribution that has been acquired, a lacking range of the plurality of sound waveforms related to the characteristic distribution, which is a range in which the characteristic distribution is smaller than a threshold value, and
displaying the lacking range.

12. The display method according to claim 11, wherein
in the displaying, a characteristic value of at least one of an upper limit and a lower limit of the lacking range is displayed.

13. The display method according to claim 11, wherein
the displaying includes
detecting, from among a plurality of musical pieces, a plurality of candidate musical pieces containing a note with a characteristic value within the lacking range, and
presenting the plurality of candidate musical pieces to a user.

14. The display method according to claim 1, wherein
the acoustic model is a model that has acquired an ability to generate second acoustic features in accordance with musical score features of a second musical piece, by being trained using training data that contain musical score features of at least a part of the plurality of sound waveforms of a first musical piece and contain first acoustic features of the plurality of sound waveforms,
the acquiring includes
acquiring history data indicating a history of the plurality of sound waveforms used for the training of the acoustic model, and
acquiring the information related to the characteristic distribution of the plurality of sound waveforms used for the training of the acoustic model, based on the history data, and
in the displaying, the information that relates to the characteristic distribution and has been acquired is displayed.

15. The display method according to claim 14, wherein
in the displaying, a degree of proficiency of the acoustic model with respect to the musical score features of the second musical piece is displayed based on the characteristic distribution that has been acquired.

16. The display method according to claim 14, wherein
the displaying includes
evaluating a degree of proficiency of the acoustic model with respect to the second musical piece based on a musical score of the second musical piece and the characteristic distribution that has been acquired, and
displaying the degree of proficiency.

17. The method according to claim 14, wherein
the displaying includes
evaluating, based on a musical score of each section of the second musical piece and the characteristic distribution that has been acquired, a degree of proficiency of the acoustic model with respect to each section of the second musical piece, and
displaying the degree of proficiency for each section.

18. The display method according to claim 14, wherein
the displaying includes
evaluating a degree of proficiency of the acoustic model with respect to each of a plurality of second musical pieces based on a plurality of musical scores of the plurality of second musical pieces and the characteristic distribution that has been acquired, and
displaying a recommendation of at least one of the plurality of second musical pieces based on the degree of proficiency.

19. The display method according to claim 14, wherein
the acquiring is performed for each of a plurality of acoustic models including the acoustic model to acquire a plurality of characteristic distribution of the plurality of acoustic models, and
in the displaying, a recommendation of one or more acoustic models matching the second musical piece is displayed based on a musical score of the second musical piece and the plurality of characteristic distributions of the plurality of acoustic models that have been acquired.

20. The display method according to claim 14, wherein
during execution of a generation method, in which portions of a musical score of a second musical piece are sequentially received, features of each of the portions of the musical score is subjected to real-time processing using the acoustic model, and a portion of the second acoustic features which corresponds to each of the portions of the musical score is generated in real time, the displaying includes
evaluating, in real time, a degree of proficiency of the acoustic model with respect to each of the portions of the musical score based on each of the portions of the musical score and the characteristic distribution that has been acquired, and
displaying the degree of proficiency evaluated in real time.
